(19) United States
(12) Patent Application Publication
(10) Pub. No.: US 2005/0093860 A1
(43) Pub. Date: May 5, 2005

(54) Information processing apparatus and method, program for executing said method, and storage medium storing said program

(76) Inventors: Ryozo Yanagisawa, Shizuoka (JP); Yoshikazu Sasago, Ibaraki (JP); Tsutomu Nishiuwatoko, Shizuoka (JP); Takashi Akutsu, Kanagawa (JP); Hiroshi Takarada, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/976,821

(22) Filed: Nov. 1, 2004

(30) Foreign Application Priority Data
Oct. 31, 2003 (JP) 2003-372457
Nov. 10, 2003 (JP) 2003-380078
Nov. 12, 2003 (JP) 2003-382684

(51) Int. Cl. G06F 19/00

(52) U.S. Cl. 345/419; 700/98

(57) ABSTRACT

Disclosed is an information processing apparatus having display means for virtually displaying planes, in which attribute information concerning a three-dimensional model is laid out, in three-dimensional space identical with that of the three-dimensional model, and output means, which is responsive to a direct designation by designating means of a plane displayed by the display means, for outputting print data of the three-dimensional model and of the attribute information as viewed from a normal-line direction of the virtual plane designated. The information processing apparatus (a 3D-CAD apparatus, for example) prints drawings more efficiently.

### FIELD OF THE INVENTION

This invention relates to an information processing apparatus and method. More particularly, the invention relates to an information processing apparatus and method for creating a three-dimensional (referred to as “3D” below) model (a 3D shape) using 3D-CAD.

### BACKGROUND OF THE INVENTION

The designing of 3D models of parts and units (referred to simply as “parts” below) that construct merchandise and products has long been performed using 3D-CAD. In such designing using 3D-CAD, attribute information such as dimensions, dimensional tolerance, geometrical tolerance, remarks and symbols is input with regard to elements such as the surfaces, ridge lines or apices of the 3D model of the designed part.

The 3D model and attribute information are printed on a recording medium such as paper in order that the designer or various technicians may write down the results of checks and investigations. The following two methods are available as methods of printing a 3D model and attribute information concerning 3D-CAD on a recording medium such as paper by a printer:

The first method is a method of transmitting the 3D-CAD 3D model and attribute information to a 2D-CAD system and creating a printout of a drawing using the 2D-CAD system.

The second method is a method in 3D-CAD of outputting to a printer or the like and printing a 3D model and attribute information within a view port (a location obtained by deciding a partially rectangular region in a diagrammatic area and adopting this region as the diagrammatic area) converted to image data as image information such as bitmap data for being displayed on a display screen such as a CRT.

With the first method of printing a 3D model and attribute information, a so-called diagram must be created in 2D-CAD in order to be printed. This is a troublesome operation. More specifically, in the creation of a diagram in 2D-CAD, it is necessary to set the view (the line-of-sight direction for displaying the 3D model), place a projection diagram and set the scale. Further, it is necessary to specify the cutting line of a sectional view as required, or to specify the range and name of a partially enlarged view, or to specify an arrow diagram. These operations can be performed in a short time if the part is simple in shape. However, if the part is large in size or of a complicated shape and many drawings such as a large number of projections, sectional views and partially enlarged views, etc., must be printed out, a great deal of time is required.

Further, the fact that the design task cannot be completed with 3D-CAD and an operation in 2D-CAD is required means that the designer is compelled to learn many operating commands. This is not a favorable working environment. Furthermore, whenever various items are checked during the course of the designing activity, a 2C-CAD drawing must be created using the latest information available at the time. This lowers efficiently markedly.

Further, with the second method of printing a 3D model and attribute information, the orientation of the 3D model must be changed whenever one sheet of the required diagrammatic information is printed. Such a method is inefficient.

### SUMMARY OF THE INVENTION

Accordingly, the present invention has been devised in view of the aforesaid problems and provides an information processing apparatus that is capable of printing out desired drawing information efficiently.

Further, the present invention provides an information processing apparatus in which the shape of a 3D model can be comprehended reliably and efficiently from drawing information and it is possible to transmit design information and the intent of design to a downstream process reliably.

According to one aspect of the present invention, an information processing apparatus comprises a display control device adapted to display a plane, in which attribute-information concerning a three-dimensional model is laid out, in three-dimensional space identical with that of the three-dimensional model; and an output device, which is responsive to designation by a designating device of the plane displayed by the display control device in the same three-dimensional space as that of the three-dimensional model, adapted to output print data of the three-dimensional model and of the attribute information as viewed from a normal-line direction of the virtual plane designated.

According to another aspect of the present invention, an information processing apparatus comprises acquisition means for acquiring information relating to set state of an attribute layout plane in which attribute information concerning a three-dimensional model is laid out and generating means for generating auxiliary drawing information, which is for clarifying set position and set direction of the attribute layout plane that is output together with information relating to the attribute layout plane, based upon information relating to the setting information.

According to a further aspect of the present invention, an information processing apparatus comprises display means for virtually displaying planes, in which attribute information concerning a three-dimensional model is laid out, in three-dimensional space identical with that of the three-dimensional model and image control means for giving a higher priority to a feature line of the three-dimensional model than to a leader line of the attribute information if the feature line and the leader line overlap.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating an information processing apparatus according to a first embodiment of the present invention;

FIG. 2 is a diagram illustrating an example of a 3D model according to the first embodiment;

FIG. 3 is a diagram in which a 3D model is expressed by 2D drawings in the first embodiment;

FIG. 4 is a flowchart of print output processing according to the first embodiment;

FIG. 5 is a diagram illustrating a 3D model and attribute layout planes as seen from a viewer according to the first embodiment;

FIG. 6 is a diagram illustrating a 3D model, an attribute layout plane and attribute information in the first embodiment;

FIGS. 7A to 7D are diagrams illustrating a case where attribute layout planes are displayed according to the first embodiment;

FIGS. 8A and 8B are diagrams useful in describing layout zones in the first embodiment;

FIG. 9 is a diagram useful in describing partitioning of a print zone in the first embodiment;

FIGS. 10A to 10D are diagrams illustrating results of printout in an embodiment of the present invention;

FIG. 11 is a block diagram of a CAD apparatus;

FIG. 12 is a flowchart illustrating processing (for appending attribute information to a model) executed by the CAD apparatus shown in FIG. 11;

FIG. 13 is a diagram illustrating a 3D model and attribute information;

FIG. 14 is a diagram illustrating a 3D model and attribute information;

FIG. 15 is a flowchart illustrating processing (for outputting print data) executed by the CAD apparatus shown in FIG. 11;

FIG. 16 is a diagram useful in describing a preview display;

FIG. 17 is a diagram for describing print information;

FIG. 18 is a diagram for describing a drawing list;

FIG. 19 is a diagram for describing a drawing list;

FIG. 20 is a flowchart illustrating a procedure for generating auxiliary drawing information;

FIGS. 21A to 21C are diagrams for describing a method of generating auxiliary drawing information;

FIG. 22 is a diagram illustrating a 3D model for which attribute layout planes have been set;

FIG. 23 is a diagram illustrating one example (1) of auxiliary drawing information;

FIG. 24 is a diagram illustrating one example (2) of auxiliary drawing information;

FIG. 25 is a diagram illustrating one example (3) of auxiliary drawing information;

FIGS. 26A and 26B are diagrams illustrating one example (4) of auxiliary drawing information;

FIG. 27 is a diagram illustrating one example (5) of auxiliary drawing information;

FIGS. 28A to 28E are diagrams for describing printouts;

FIG. 29 is a diagram illustrating 3D model according to a third embodiment of the present invention;

FIG. 30 is a flowchart for describing processing according to the third embodiment;

FIG. 31 is a diagram illustrating a 3D model and attribute layout planes in the third embodiment;

FIG. 32 is a diagram illustrating a 3D model, an attribute layout plane and attribute information in the third embodiment;

FIG. 33 is a diagram for describing a layout zone and a print zone in the third embodiment;

FIG. 34 is a diagram illustrating a case where an attribute layout plane is displayed in the third embodiment;

FIG. 35 is a flowchart of image processing in an information processing apparatus according to the third embodiment;

FIG. 36 is a diagram illustrating result of printout in the third embodiment;

FIG. 37 is a flowchart of other image processing in an information processing apparatus according to the third embodiment;

FIG. 38 is a diagram illustrating a case where an attribute layout plane is displayed according to the prior art; and

FIG. 39 is a diagram illustrating examples of shapes conceivable from attribute layout planes according to the prior art.

### DETAILED DESCRIPTION OF THE PREFERRED EMBODIMENTS

### A. First Embodiment

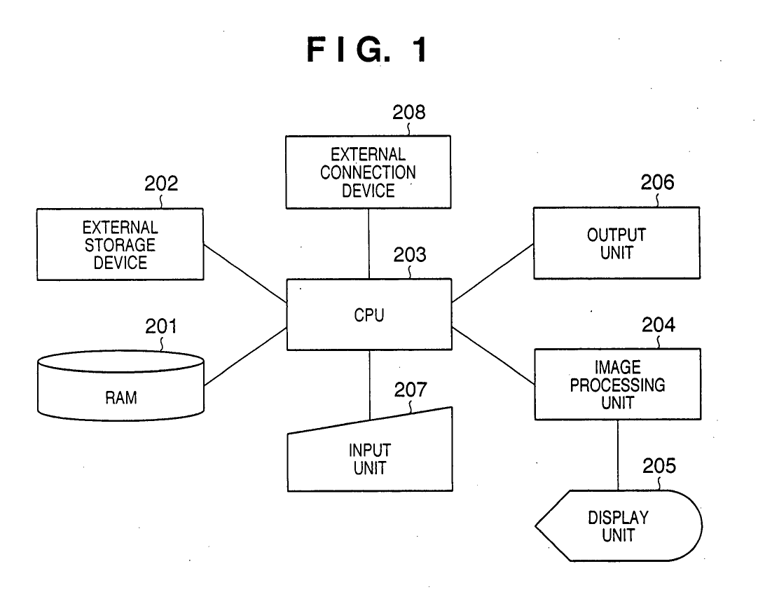

A first embodiment of the present invention will be described in detail with reference to FIGS. 1 to 10D.

FIG. 1 is a block diagram of a 3D-CAD apparatus, which is an information processing apparatus according to this embodiment. As shown in FIG. 1, the information processing apparatus has a RAM 201 for expanding CAD data and an operation processing program according to this embodiment, and an external storage device 202 such as a hard disk for storing the CAD data and operation processing program. The information processing apparatus further includes a CPU 203 for executing processing based upon the program that has been expanded in the RAM 201, and an image processing unit 204 for subjecting geometric data representing a geometric shape, which is sent from the CPU 203, to geometric calculations such as so-called clipping and shading, computing pixel data of image data, executing rasterization processing such as hidden-surface processing, storing the processed data in a storage device (display buffer), which is not shown, and outputting the image data to a display unit 205, described later.

The information processing apparatus further includes the display unit 205 for displaying the shape of a 3D model and attribute information, etc., based upon the pixel data that is output from the image processing unit 204 on the basis of an instruction executed by the CPU 203. When the shape of the 3D model and attribute information are displayed on the display unit 205, the display zone can be decided using a CAD function such as zooming, panning and rotation. More specifically, the display zone can be decided by the position of a point of view with respect to the 3D model and by the line-of-sight direction (viewing axis) when the 3D model is seen from the point-of-view position, the viewing angle and the visual-field range (visual-field space) along the point-of-view direction, etc.

The information processing apparatus further includes an output unit 206 serving as a printer or plotter. In the flow of print processing, first the image data rasterized by the image processing unit 204 is stored temporarily in the RAM 201 and image data in a prescribed format obtained by conversion based upon processing by the CPU 203 is printed out on a recording medium such as paper. The printout is an output of image data such as bitmap data obtained utilizing the image data rasterized by the image processing unit 204. This data undergoes only simple processing and can be printed out in a short time.

An input unit 207 is constituted by a mouse and keyboard, etc., for applying commands to a CAD program. Further, an external connection device 208 connects the information processing apparatus to an external unit and is for performing an exchange of data between the apparatus and the external unit.

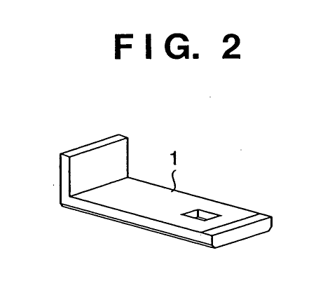

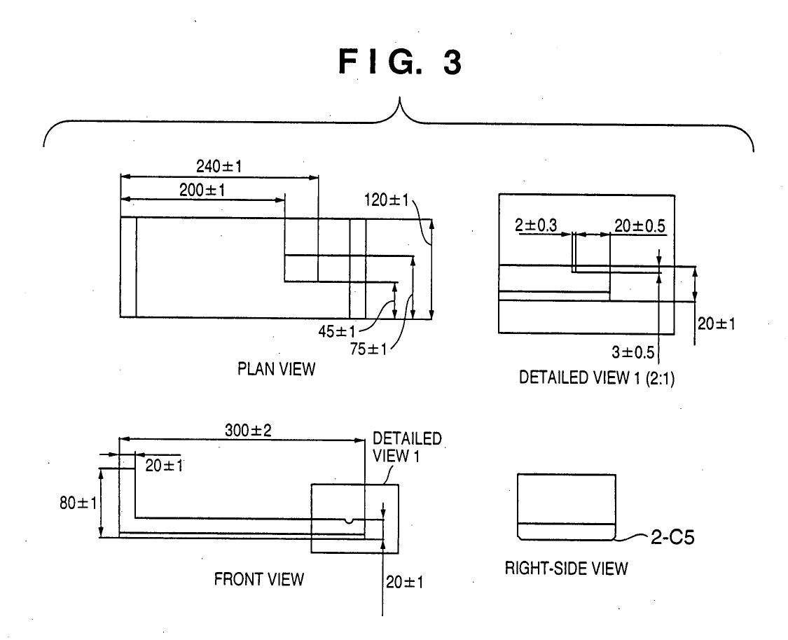

FIG. 2 illustrates an example of a 3D model used for description in this embodiment. Though a part having a comparatively simple shape is used in this embodiment in order to simplify the description, the approach of the present embodiment can of course be applied to a part of a complicated shape having several hundred to several thousand elements. An example in which a 3D model 1 in FIG. 2 is expressed by dimensions in a so-called 2D drawing is illustrated in FIG. 3. In FIG. 3, the 3D model 1 is illustrated in a front view, plan view, right-side view and detailed view in which the drawing is enlarged by a factor of two.

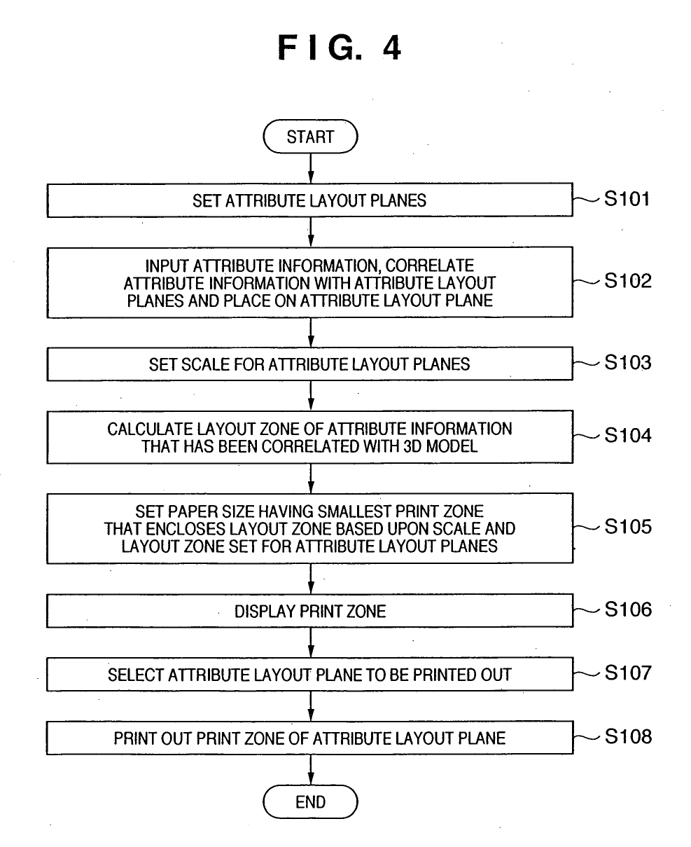

Drawing printout processing in this embodiment will be described from setting of attribute information in line with the flowchart of FIG. 4 using the 3D model 1 shown in FIG. 2.

First, at step S101, attribute layout planes 2a, 2b, 2c and 2d (see FIG. 5) for expressing attribute information such as dimensions and tolerance of the 3D model 1 are set with regard to the 3D model 1. The attribute layout planes 2a to 2d in FIG. 5 correspond to the front, plan, right-side and detailed views, respectively, of FIG. 3.

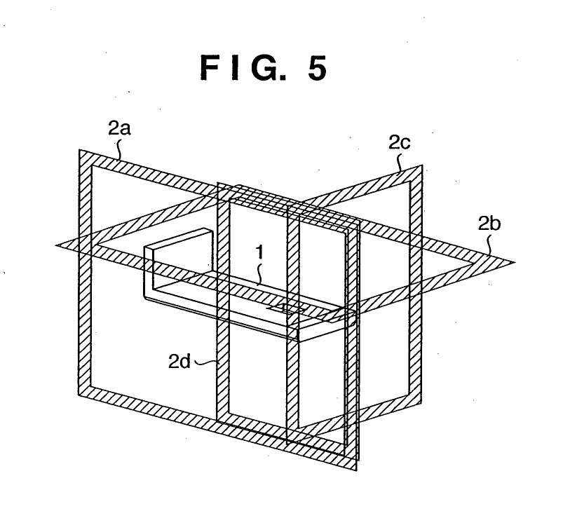

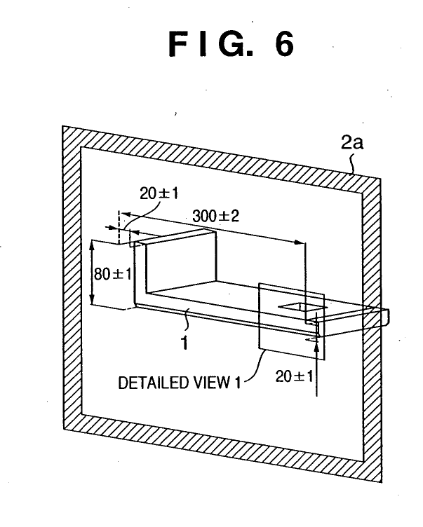

Next, at step S102, the necessary attribute information such as dimensions is input, the attribute information is correlated with any of the attribute layout planes 2a to 2d and is placed at desired positions on the attribute layout planes 2a to 2d. FIG. 6 illustrates an example in which attribute information has been correlated with the attribute layout plane 2a.

Next, at step S103, a scale that allows the shape of the 3D model 1 and attribute information to be seen clearly without being misunderstood is set for the attribute layout planes 2a to 2d. In this embodiment, a scale of 1:1 is set with regard to the attribute layout planes 2a, 2b, 2c, and a scale of 2:1 is set with regard to the attribute layout plane 2d that corresponds to the detailed view. The display and printout of the 3D model 1 and attribute information are executed based upon the scales set.

Further, calibration of the scale is performed before the scale is set. The calibration is carried out upon fixing the size of the view port that displays the 3D space of the display unit 205. The CAD program causes a line segment of known length to be displayed on the display screen in any display zone in 3D space, namely at any degree of zoom. The length of the desired line segment differs from the actual length depending upon the degree of zoom. The displayed length of the line segment is measured by an actual measuring rule and the result of measurement is input. The CAD program compares the result of measurement and the above-mentioned known length, thereby making the display zone a display zone that conforms to the scale.

For example, in a case where the result of measuring a line segment having a known length of 100 mm is 150 mm, the display is reduced by a factor of ⅔ vertically and horizontally by zooming. In other words, by setting the display zone of the 3D space to 1.5× vertically and horizontally, the length of 100 mm will be displayed on the display screen also within the 3D space so that a 1:1 display becomes possible.

Further, by changing the display zone from this state in accordance with various scales, displays conforming to various scales become possible. Further, by storing the display zone and the result of measurement in advance, a display conforming to scale becomes possible at any time. Furthermore, by-setting the size of characters or the like in the attribute information in inverse proportional to the scale, attribute information can be displayed at the same size irrespective of the scale when a display conforming to scale is presented.

For example, if the size of a character in attribute information is made 4 mm when the scale is 1:1 and 0.8 mm when the scale is 5:1, then the size of the characters in the display information will always be 4 mm when a display conforming to scale is presented. As a result, a display that is easy to read can be obtained.

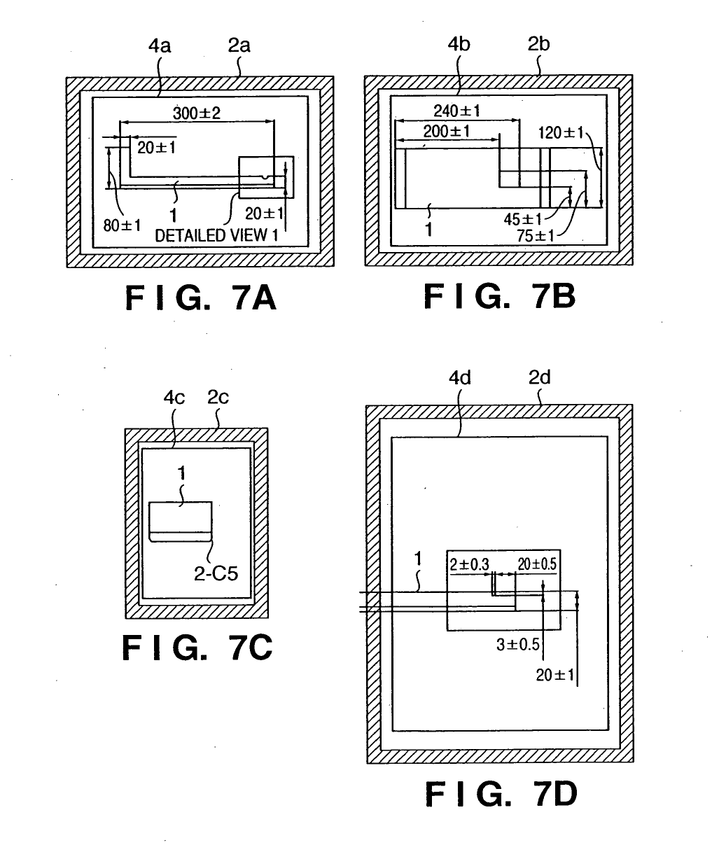

The display state when the attribute layout planes 2a to 2d are displayed face-up is illustrated in FIGS. 7A to 7D. FIG. 7D illustrates the details of the shape (groove) clearly, where the scale is 2:1. It should be noted that in FIGS. 7A to 7D, the characters of the attribute information are expressed in large size with respect to the 3D model for the sake of description.

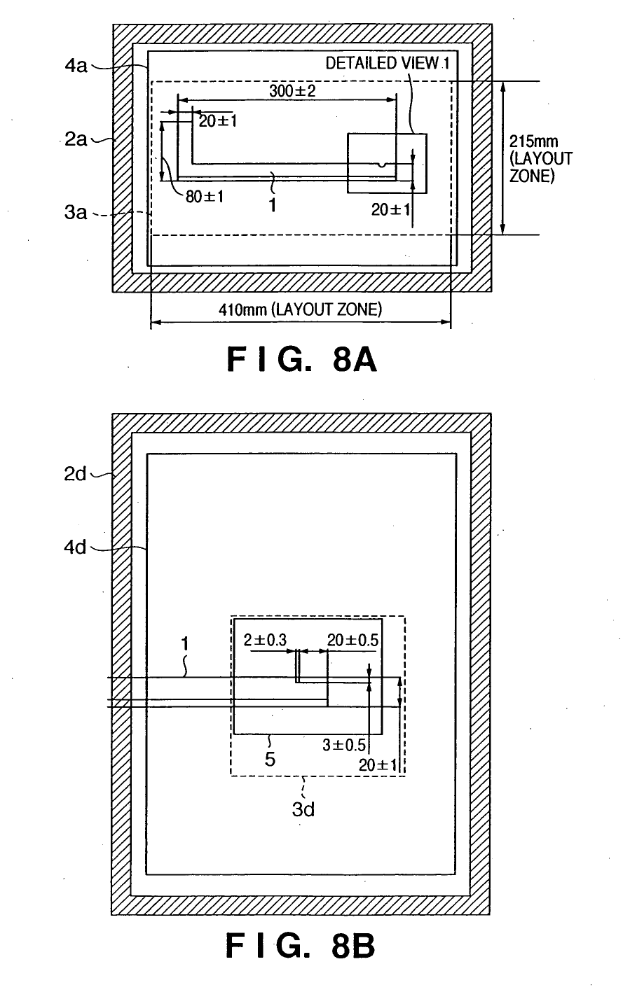

Next, at step S104, the layout zone within the 3D space of the attribute information that has been correlated with the 3D model 1 is calculated for each of the attribute layout planes 2a to 2d. The layout zone is calculated as a rectangular shape that encompasses the entirety of the 3D model 1 and correlated attribute information in a display state in which the attribute layout planes 2a to 2d are displayed face-up. For example, the area enclosed by the line in FIG. 8A is a layout zone 3a.

This is followed by step S105, at which the apparatus selects, from the set scale and layout zone 3a, a recording medium such as paper having a print zone 4a (the solid line) of the smallest size that encloses the planar model indicated by the dotted line and the layout zone 3a of the attribute information. For example, in a case where the scale is 1:1 and the layout zone 3a is 215×410, as shown in FIG. 8A, a recording medium of size A3 (297×420 mm), is selected. On the other hand, in case of 430 mm, this will not fit in size A3 and therefore size A2 (420×594 mm) is selected. Further, in a case where the scale is 2:1 in FIG. 8A, the layout zone 3a in 3D space becomes 215×410 mm. However, since the actual zone is 430×820 mm, size A1 (594×841 mm) is selected.

Further, in an attribute layout plane 2d that corresponds to the detailed view of FIG. 3, a layout zone 3d becomes a rectangular shape that encloses a desired detailed area 5 (the solid line) that has been preset and the attribute information correlated with this area, as illustrated in FIG. 8B.

This embodiment is such that in the case of attribute layout planes 2a and 2b, a recording medium of size A3 corresponding to the print zones 4a and 4b is selected, and in the case of attribute layout planes 2c and 2d, a recording medium of size A4 corresponding to the print zones 4c and 4d is selected (FIGS. 7A to 7D).

The set-up is such that the center of the layout zone 3a will coincide with the center of the print zone 4a of the selected recording medium (FIG. 8A). Of course, the layout zone may be revised by shifting it relative to the print zone as necessary (FIG. 8B).

Next, the print zone is displayed at step S106. That is, the print zones 4a to 4d are displayed as rectangles, for example, on the attribute layout planes 2a to 2d (FIGS. 7A to 7D). If the display screen is made a display zone conforming to the scale at this time, the sizes of the print zones 4a to 4e displayed will be the same as the sizes of the actual print zones. That is, if a printing medium of size A3 is laid on the display screen of print zone 4a or 4b of size A3, for example, then both print zones will coincide. By displaying the print zones 4a to 4d, the user can clearly ascertain the range over which printing can be performed.

Next, any of the attribute layout planes 2a to 2d to be printed out is selected and specified at step S107. When the layout plane is selected and specified, the display state of the display screen may be any state. Specifically, the attribute layout plane is selected and specified irrespective of the line-of-sight direction that sets the display direction in 3D space, the direction of the normal to the attribute layout plane selected and the display zone decided by the visual-field range. For example, a drawing of the attribute layout plane to be printed can be selected in a display state of the view direction (the direction in which the 3D model is seen from a certain point of view), which is not parallel to to the direction of the normal line to the attribute layout plane, of the kind shown in FIG. 5 or 6.

For example, the selection is executed by selecting the frame of an attribute layout plane (e.g., the frame of the attribute layout plane 2a in FIG. 5 or FIG. 6) directly by moving a cursor using a mouse, or by entering the name of the attribute layout plane using a keyboard. By selecting a plurality of drawings while verifying them in the view direction in which such a 3D model is seen from a certain point of view, and by printing out these drawings at one time, the user can make print selection processing more efficient. It should be noted that when a drawing is selected, the user is made aware of a selected attribute layout plane through use of a color that differs from that of a non-selected attribute layout plane, thereby making it possible to assist the selection of the drawing by the user.

Next, at step S108, the 3D model 1 as seen from the direction of the normal to the designated attribute layout plane (namely the attribute layout plane displayed face-up) and the attribute information that has been correlated with the attribute layout plane are printed out by an output operation using the print zone and stipulated paper size set at step S105. More specifically, image information within the print zone set on the attribute layout plane to be output is converted to a prescribed format in the image processing unit 204, after which the information is stored temporarily in RAM 201 and sent to the output unit 206, whereby the information is printed out using the set size of the recording medium. The image information of the 3D model at this time is printed on a recording medium of size A4 corresponding to the print zone 4a set based upon the scale. That is, the result of printout reflects the scale of the 3D model.

Here processing is executed such that the display of the attribute layout plane whose printout has been completed is given a color different from that of other attribute layout planes on the display screen (FIG. 5) of the display unit 205. For example, a different display that can be identified by the operator can be applied, as by changing the color of the frame of the relevant attribute layout plane or by appending a mark to inform the operator that the selection has been completed or that printout has been completed. As a result, a plurality of attribute layout planes can be selected efficiently and without error.

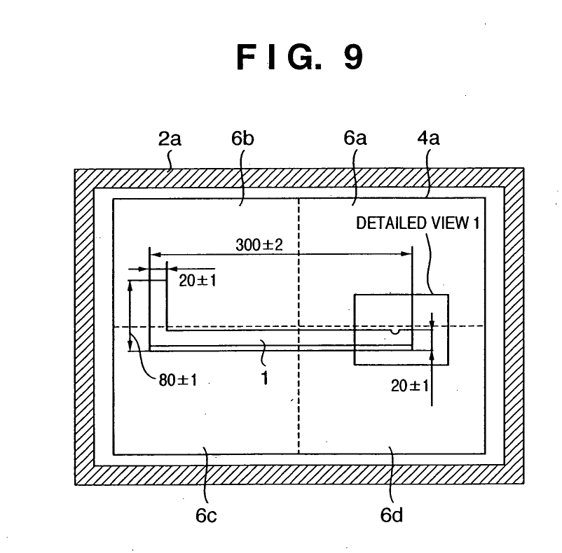

Owing to size limitations on the display unit 205, there are cases where the entire print zone will not be displayed on the display screen if the display is presented in the scale that has been set on the attribute layout plane. In such cases the print zone is divided into two, four or nine sections, etc., and the image information in each divided zone is transferred to and output by the output unit 206. FIG. 9 illustrates a state in which the print zone 4a has been divided into four sections 6a to 6d.

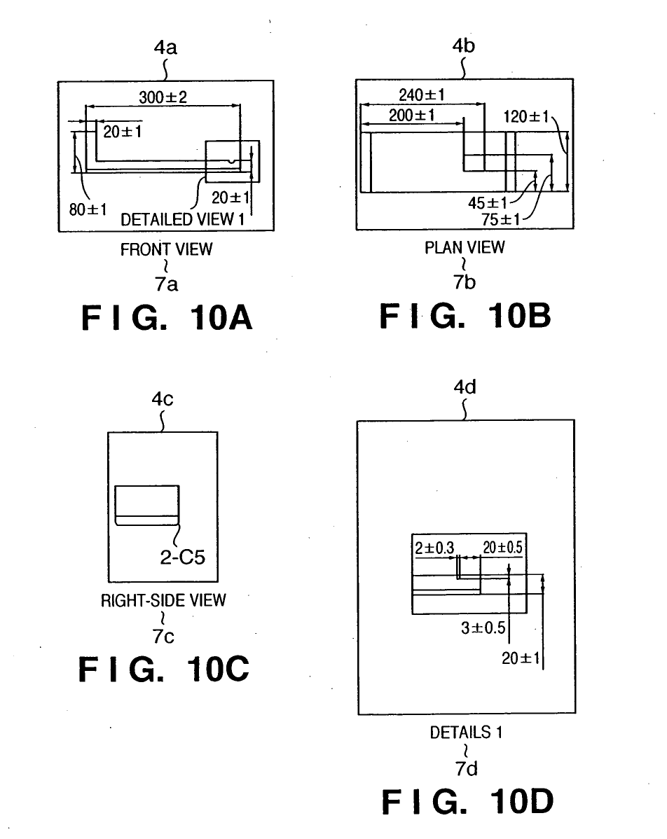

Results obtained by printout performed for each of the attribute layout planes 2a, 2b, 2c and 2d are illustrated in FIGS. 10A to 10D. In the results of printout, shading is applied to the 3D model 1 as necessary. Furthermore, in order to clarify the distinction between the 3D model 1 and the attribute information or leaderline of the attribute information, the results of printing may be printed out using different colors for each of these.

With regard to background in which the 3D model 1 and attribute information, etc., do not exist, the 3D model 1 and attribute information, etc., become more clearly defined by using the color white for the background, i.e., by printing out nothing for background. Further, if names 7a to 7d of the individual attribute layout planes are printed out by being incorporated in the print data when each of the attribute layout planes is printed out, it can be understood more efficiently which attribute layout plane is being displayed face-up in the result of printout.

In this embodiment, as described above, the desired drawing information can be printed out efficiently. In other words, a drawing to be printed out can be selected efficiently irrespective of the display state of the display screen, and the entirety of the 3D model and attribute information that prevails when the attribute layout planes are displayed face-up can be printed out in the desired scale and required size for each individual attribute layout plane.

Further, though there is no description regarding the resolution of the display unit 205 and output unit 206 in the above embodiment, these units can be applied in this embodiment regardless of resolution. For example, if the display unit 205 has 1280×1024 pixels horizontally and vertically, respectively, and the pixel size is 0.25×0.25 mm, the display screen of the display unit 205 will have a size 320×256 pixels horizontally and vertically, respectively, and the resolution will be approximately 100 dpi. A print zone of size A4 (297×210 mm) can be set for the display screen and a printout can be performed on a recording medium of size A4 by a output unit 206 having a resolution of 600 dpi, by way of example.

It should be noted that the result of printout at this time is an output equivalent to 100 dpi and there may be cases where this resolution is not satisfactory, depending upon the shape of the 3D model. In such cases the print zone is divided, image information prevailing when the divided zones are displayed in enlarged form is combined and the combined information can be printed in the size of the recording medium set at the output unit 206, thereby making it possible to obtain a printout corresponding to approximately 400 dpi.

For example, with the display unit 205, the print zone is divided into 4×4 or 16 sections, each section obtained by such division is enlarged by a factor of four to obtain display image information and the 16 sections are combined and printed out, whereby a printout corresponding to about 400 dpi can be obtained. When a display is presented at the scale set on an attribute layout plane, the above can be applied similarly also in a case where the entirety of the print zone cannot be displayed to fit the display screen. A printout having satisfactory resolution can be obtained as necessary, without a limitation on number of divisions, within the satisfactory limits of storage capacity available in the 3D-CAD apparatus inclusive of a memory prepared in the output unit 206.

Further, in the above embodiment, a printout is obtained utilizing image information in a case where a display is presented at the scale set on the attribute layout planes. However, since the print zone and the size of recording medium corresponding to the print zone have been set, the present invention can also be applied to a situation where image information within the print zone is converted to the size of the recording medium and then printed out at any zoom rate that displays the entire print zone.

In the above embodiment, the apparatus includes the image processing unit 204. However, the image processing function may be incorporated in the CPU 203.

Further, in the above embodiment, the scale of the attribute layout plane or the print zone is set after the attribute information is input. However, the present invention can be applied irrespective of the order of the above-mentioned operations. For example, the scale of an attribute layout plane may be set during the creation of the 3D model. Further, the operator can specify the print zone at any time. For example, the print zone can be set by specifying any position on an attribute layout plane, or a position relative to the 3D model, and the size of the print zone.

Further, in the above embodiment, it may be so arranged that the size of the print zone or the size of the corresponding recording medium is displayed. In this case, any display method may be used. For example, the name of a size or a numerical value indicating the size may be displayed in the vicinity of any of the four corners of the rectangle indicating the print zone, or these may be displayed inside the frame of the rectangle, or the size may be displayed temporarily when a pointer is situated in the vicinity of a line of the rectangle defining the print zone.

Further, in the above embodiment, the print zone is set based upon the scale set on the attribute layout plane. However, it may be so arranged that a print zone conforming to the scale is prepared in advance and the print zone is placed on the attribute layout plane.

Further, a printout may be performed upon reducing the set print zone as necessary.

Further, the specific color of image information, e.g., the color that expresses the ridge lines of a 3D model, may be subjected to so-called enhancement processing by the image processing unit 204. In enhancement processing, the pixels surrounding a pixel corresponding to the relevant color are changed to the relevant color and adopted as image information. As a result, the ridge lines of the 3D model can be printed out as bold lines, for example, and it is possible to obtain an error-free printout result that is easier to read.

In the above embodiment, image data such as bitmap data is output to the output unit 206. However, it may be so arranged that the image processing unit 204 generates a vector, which is the line segment of a raster, from the geometric data of a geometrical shape sent from the read-aloud-item identifying unit 203, and outputs the vector data.

### B. Second Embodiment

A second embodiment of the present invention will be described in detail with reference to the drawings.

(Structure of Information Processing Apparatus and Flow of Operation)

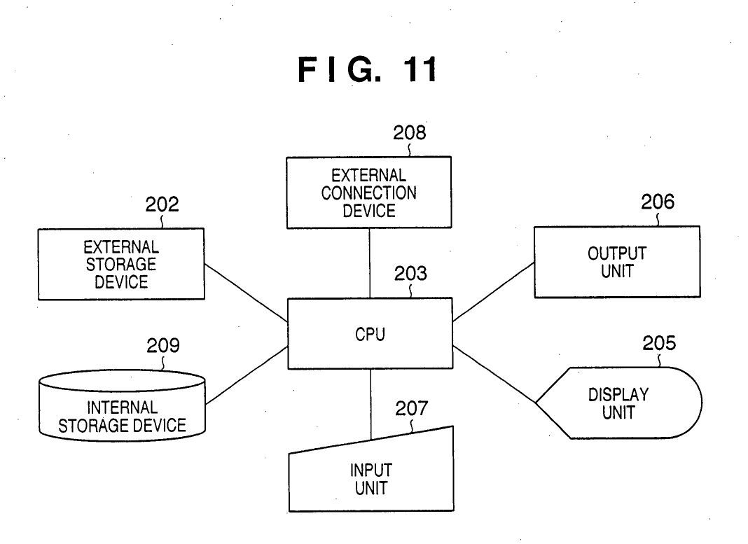

Reference will be had to FIGS. 11 to 14 to describe the structure of the information processing apparatus and the flow of an operation for performing printout after attribute information is appended to a 3D model that has been created by the information processing apparatus.

FIG. 11 is a block diagram of a CAD apparatus serving as the information processing apparatus. The apparatus includes an internal storage device 209 such as a RAM for expanding CAD data and a CAD program; an external storage device 202 such as a hard disk for storing the CAD data and CAD program; a CPU 203 for executing processing in accordance with instructions from the CAD program; a display unit 205 for displaying shapes and the like in accordance with instructions executed by the CPU 203; an input unit 207 such as a mouse and keyboard for applying commands to the CAD program; an output unit 206 such as a printer for outputting paper drawings in accordance with instructions executed by the CPU 203; and an external connection device 208 for connecting the CAD apparatus to an external unit, supplying data from the apparatus to the external unit and controlling the apparatus from the external unit.

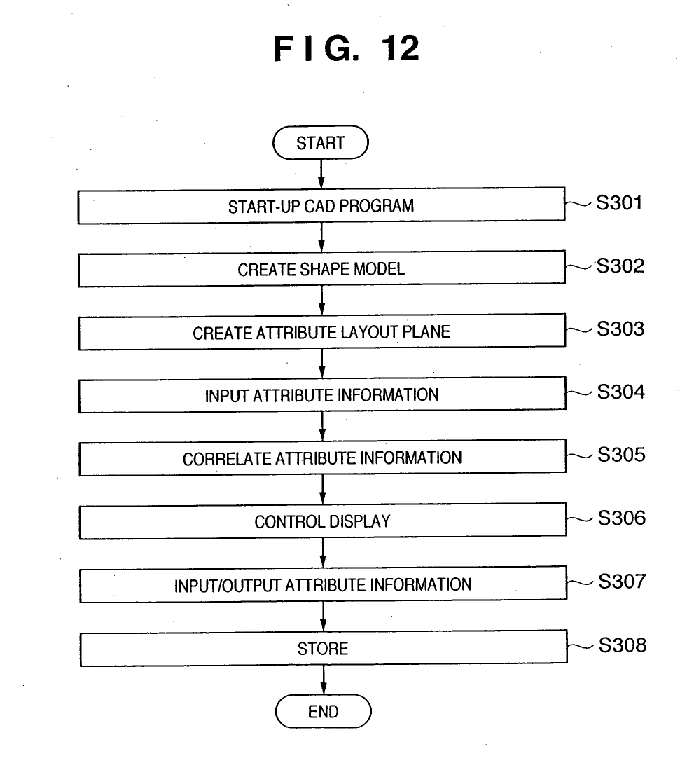

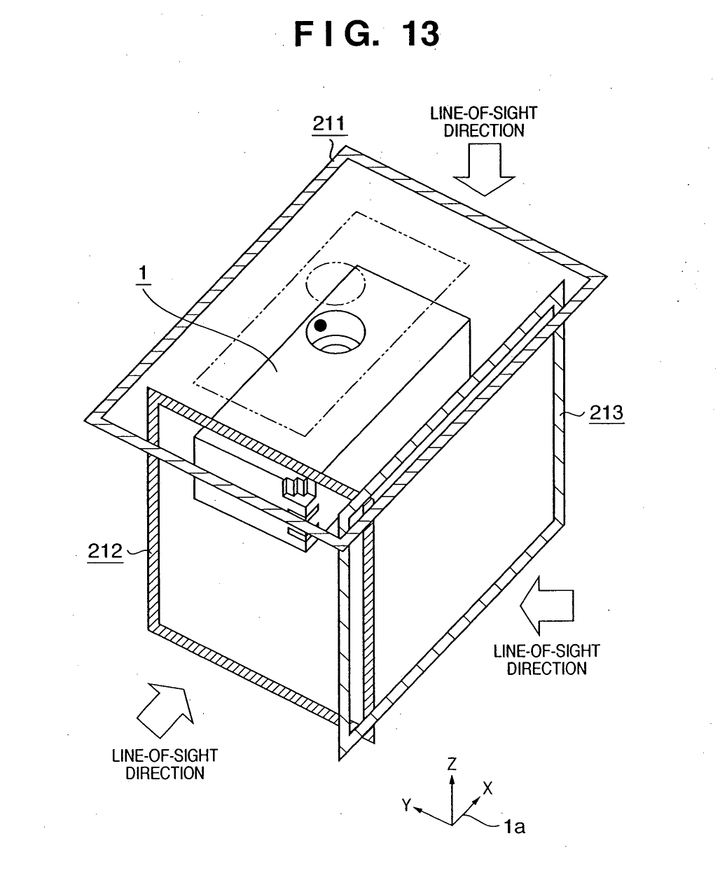

FIG. 12 is a flowchart illustrating creation of a shape model by the CAD apparatus shown in FIG. 11 and the operation of the CPU for appending attribute information to the shape model.

First, when start-up of the CAD program is specified in response to an input operation by the operator using the input unit 207, the CAD program that has been stored in the external storage device 202 is read into the internal storage device 209 and the CAD program is executed by the CPU 203 (step S301).

Furthermore, by entering commands interactively through an input operation by the operator using the input unit 207, a shape model 1 of the kind shown in FIG. 13 is created and displayed as an image on the display unit 205 (step S302).

Further, an attribute layout plane, which is a virtual plane for laying out attribute information such as dimensions and remarks, is created within the three-dimensional space in which the shape model is created in accordance with the input operation by the operator using the input unit 207 (step S303). In FIG. 13, planes 211, 212 and 213 are indicated as attribute layout planes. In the creation of the attribute layout planes, the operator sets the names of the attribute layout planes, the positions of the attribute layout planes in virtual three-dimensional space, the line-of-sight directions (a direction along which a 3D model projected on the attribute layout plane and the dimensions can be verified from a certain point of view, this direction being perpendicular to the plane of the attribute layout plane), the display magnification of the attribute information, and information relating to vertical orientation in a case where an attribute layout plane is seen as a drawing.

A frame (double borders, a filled-in border), etc., is displayed on the display unit 205 as image information in such a manner that the position of the attribute layout plane is easy to discriminate. Further, a name is set on the created attribute layout plane and it is possible to present the display at a prescribed position of the attribute layout plane as a name label. The set information of the attribute layout plane is stored in the external storage device 202 in correlation with the shape model.

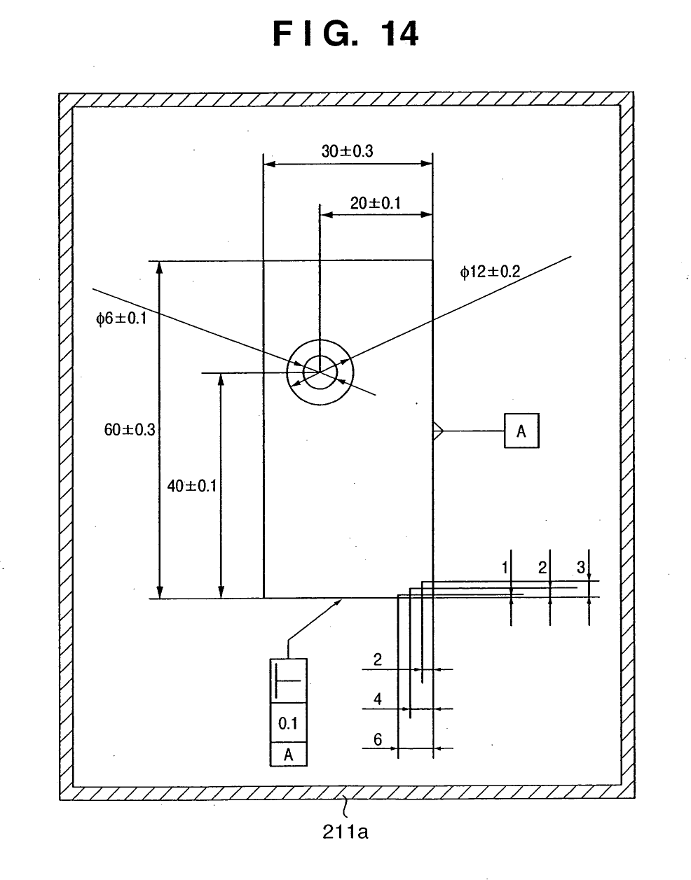

In accordance with the input operation by the operator using the input unit 207, design information such as dimensional tolerance, material name and machining instructions and management information such as part name and revision history is appended to the shape model of FIG. 13 as attribute information (step S304). The appended attribute information can be displayed on the display unit as image information, as shown in FIG. 14, by way of example. Further, the attribute information is utilized at the time of printout. The appended attribute information is stored in the external storage device 202 in correlation with the shape model.

Furthermore, the attribute information is correlated with attribute layout planes in accordance with the input operation by the operator using the input unit 207 (step S305). At this time, the attribute layout planes and the positions of the desired points of view, line-of-sight directions and magnification for the 3D model are correlated. By performing such correlation, the 3D model can be displayed based upon the set positions of the points of view, line-of-sight directions and magnification. Further, since the attribute layout planes and attribute information have been correlated, the attribute information that has been correlated with a specified attribute layout plane can be displayed selectively. Further, the information of the point-of-view position, line-of-sight direction, magnification and up direction in a case where an attribute layout plane is seen as a drawing is utilized also at the time of printout, described later. The information relating to display of attribute layout planes set as described above is stored in the external connection device 208.

The information relating to attribute information and attribute layout planes is stored in the internal storage device 209. It may be so arranged that the operator specifies an attribute layout plane in advance and appends attributes while correlating them with the attribute layout plane. Further, the correlating of the attribute information with the attribute layout plane can be set and cancelled by the operator using the input unit 207.

Next, display control is carried out for displaying or not displaying attribute layout planes specified in accordance with the input operation by the operator using the input unit 207 and the attribute information such as dimensional tolerance correlated with the attribute layout planes, or for adding on color (step S306).

The attribute information is stored in the external storage device 202, etc., in accordance with the input operation by the operator using the input unit 207 (step S307).

In accordance with the input operation by the operator using the input unit 207, the CAD attribute model obtained by appending the position information of the attribute layout planes, the display information of the attribute layout planes and the attribute information to the shape model is stored in the external storage device 202 (step S308).

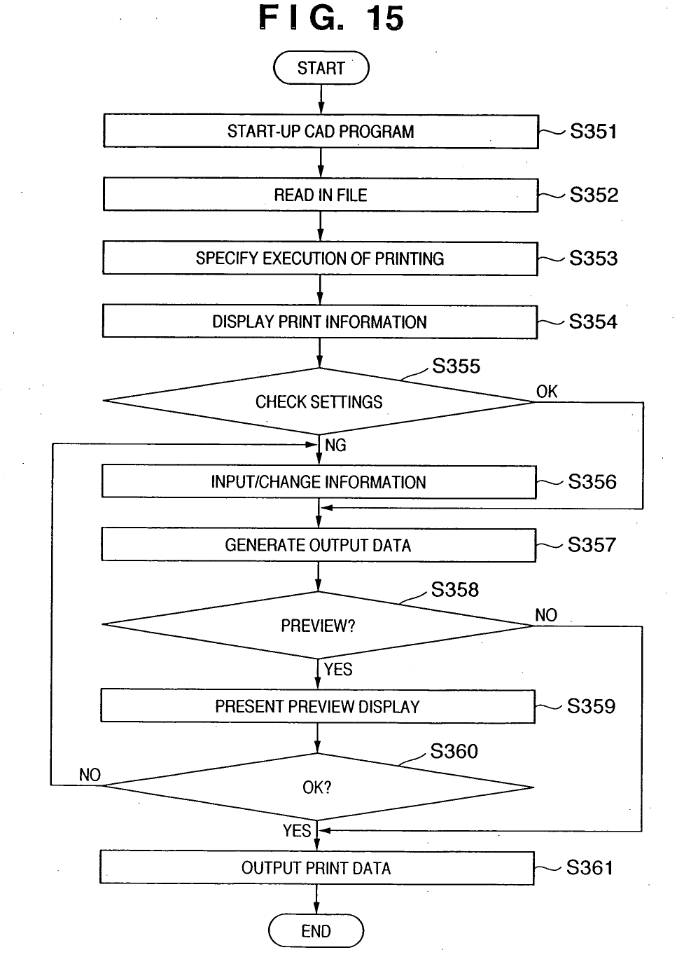

Next, reference will be had to FIG. 15 to describe the flow of the operation for printing out a shape model created by the above-described operation and attribute information that has been appended to the shape model.

FIG. 15 is a flowchart illustrating the operation for printing out information of a shape model to which attribute information has been appended. This operation is performed by the CPU 203 of the CAD apparatus shown in FIG. 11.

First, the CAD program is started up by a procedure similar to that of step S301 described above (step S351).

Next, by entering commands interactively using the input unit 207, the operator reads a desired file into the internal storage device 209 from the external storage device 202 and displays the file on the display unit 205 as an image (step S352).

Execution of printing is specified in accordance with a command from the user who has confirmed the display on the display unit 205 (step S353).

When execution of printing is specified, information necessary for performing printout is acquired from the file read in at step S352 and the print information is displayed on the display unit 205 based upon the information acquired (step S354). The print information is print format information such as the printer used, number of print copies and page set-up, attribute information such as dimensions, material name, description, drawing border and drawing number, and printout information indicating whether or not to output auxiliary drawing information for clarifying set position and set direction of attribute layout planes.

The operator uses the display unit 205 to check the print information displayed at step S354 and determines whether the settings are acceptable (step S355). If a change or addition to settings has been specified, control proceeds to step S356, at which a change or addition to the settings is made based upon the input from the input unit 207. It may be so arranged that a change in settings of the attribute information is performed by making a change or addition to settings on the display screen of print information executed at step S354. If a change or addition to settings is unnecessary, control proceeds to step S357.

Next, on the basis of the settings finalized at steps S355, S356, data for output to an output unit such as the display unit or printer is generated (step S357).

The details of print information such as the auxiliary drawing information will be described later.

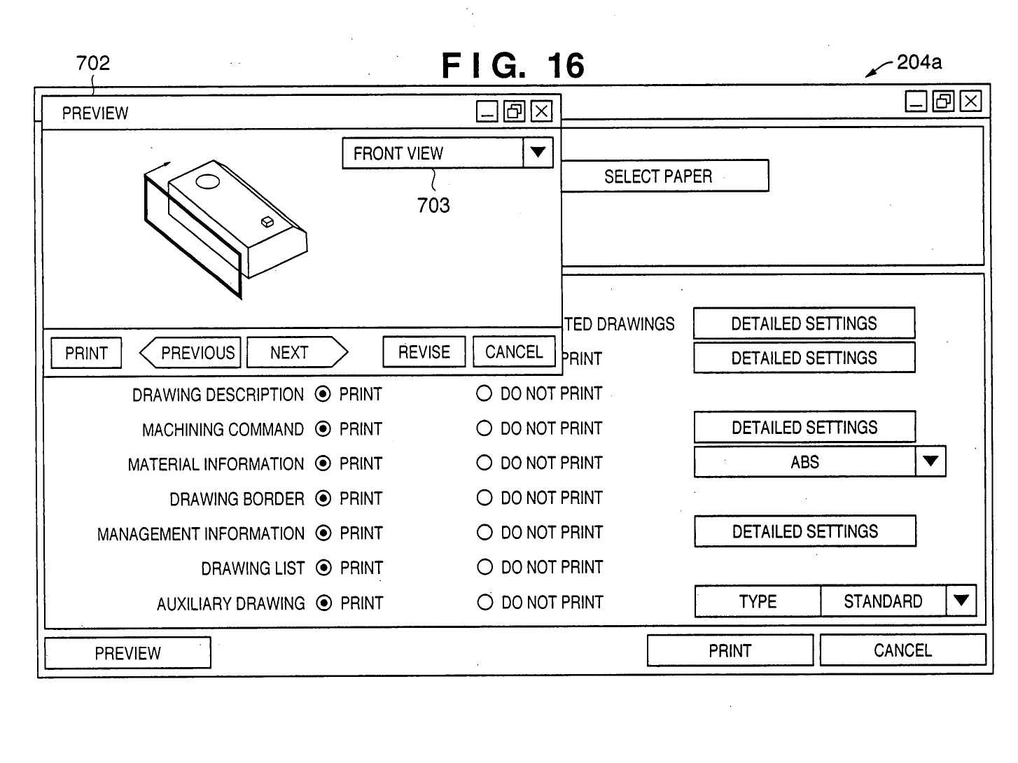

After the output data is generated, it is determined whether the operator has specified a check (preview display) on the display unit 205 of the state of printout in advance (step S358). If it is determined that a check has been specified, control proceeds to step S359; if not, control proceeds to step S361. Prescribed processing is applied to the output data generated at step S357 and a preview image is displayed on the display unit 205 at step S359 (see FIG. 16).

It is determined whether the operator has commanded execution of print processing (step S360). If the operator has commanded execution of print processing, then control proceeds to step S361. On the other hand, if it is necessary to change a setting, control proceeds to step S356. Here the above-described processing for changing settings is executed again.

The output data generated at step S357 is subjected to prescribed processing at step S361. For example, print data such as bitmap data is output to a prescribed printer and printing is executed by the printer to thereby complete-processing. The output unit for executing printing may be the output unit 206 and it is also permissible to use another output unit connected to the CAD apparatus via a network line or the like.

The steps for printing out a 3D model to which attribute information has been appended will now be described in detail.

(Acquisition and Display of Print Information: Steps S352 to S357)

When execution of printing is specified by the operator as mentioned above, the information necessary for performing printout is acquired from the file read in, the print settings are made and output data is generated and printing executed based upon the settings. The acquisition and display of print information will be described first.

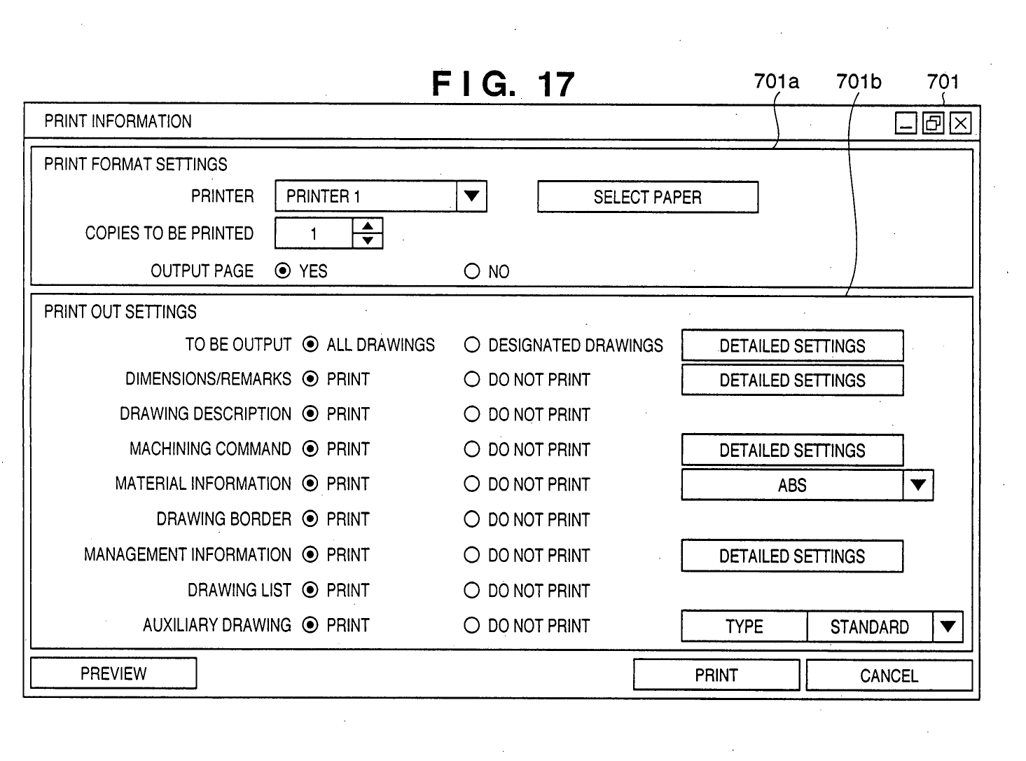

FIG. 17 illustrates an example of print information displayed on the display unit 205.

In FIG. 17, a print-information display window 701 is composed of a print-format setting area 701a and printout setting area 701b. In this embodiment, it is possible to check the content of settings and to add to or change settings on the window illustrated in FIG. 17.

Designation of the printer to perform printout and setting of number of copies to be printed are performed in the print-format setting area 701a. The settings information has been stored in the internal storage device 209 or appended to the file read in. The operator confirms the print-format settings information and, when necessary, adds to or changes the settings from the input unit 207.

With regard to printout of attribute information appended to the read-in file as attribute information, settings are checked item by item in the printout setting area 701b and, when necessary, adds to or changes the settings from the input unit 207.

A dimensions/remarks items being indicated in the printout setting area 701b relate to attribute information that has been appended to the shape elements such as the planes and ridge lines of the 3D model and correlated with the attribute layout planes. The various items of drawing description, machining command, material information, drawing border and management information relates to attribute information that has been appended to the 3D model. These items of attribute information are stored as one file together with the shape data of the 3D model.

Further, the drawing list and auxiliary drawing information is information generated from the settings on the attribute layout planes set for the 3D model. These items of information may be stored in a file together with the shape data of the 3D file in a manner similar to that of the attribute information or may be generated when printing is executed or when the preview display is presented. The drawing list and auxiliary drawing information will be described in detail later.

If the setting of print information is completed by the above-described operation, the output data is generated based upon these settings.

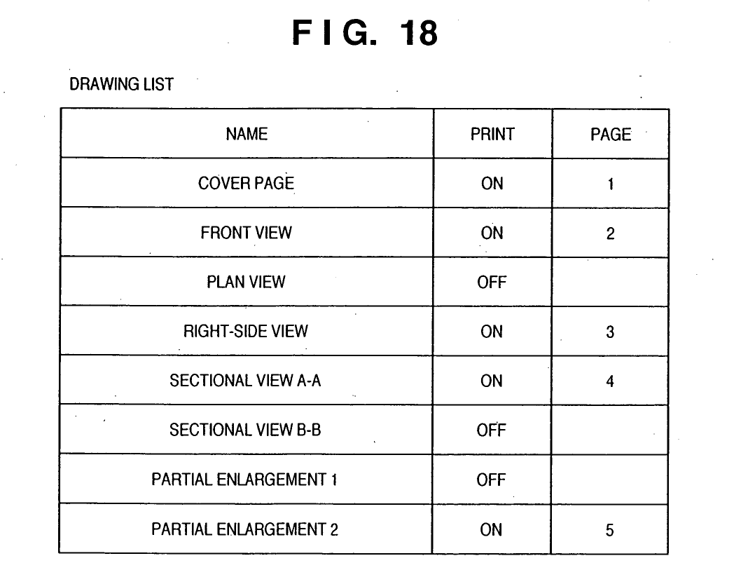

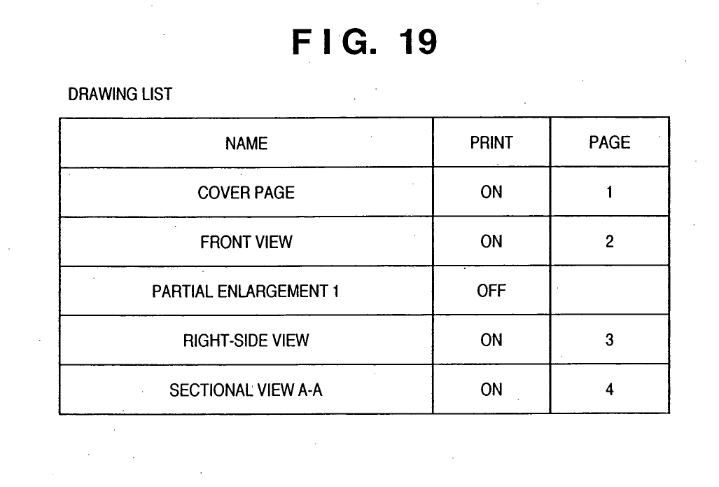

The drawing list will now be described. FIGS. 18 and 19 are diagrams illustrating examples of drawing lists.

If the printing of a drawing list is selected in the setting of print information described above, the drawing list is generated from the settings information of the attribute layout planes correlated with the 3D model. More specifically, the names of the attribute layout planes are acquired and the drawing list is generated in accordance with an order that has been set in the CAD program in advance.

The order of the drawing list may be set for every type of drawing, such as projection view, sectional view and partially enlarged view. For example, in case of projection views, the set order of the drawings may be front view, plan view, right-side view, left-side view, bottom view and back view, and the ones for which relevant attribute layout planes exist may be listed up in accordance with this order. In case of sectional views, the views may be set in alphabetical order starting from A-A. In case of partially enlarged views, the views may be set in order of ascending numerals (see FIG. 18).

In the printout setting area 701b in this embodiment, the set-up is such that an attribute layout plane selected for printing is displayed as ON in the list, and an attribute layout plane not selected for printing is displayed as OFF in the list. Accordingly, even in a case where only some of the attribute layout planes are printed out from among the plurality of attribute layout planes set for the 3D model, the presence of all of the attribute layout planes that have been set can be ascertained from the list.

Further, as shown in FIG. 19, the list may be displayed in such a manner that a setting of a parental relationship between a sectional view and partially enlarged views can be determined from the list. In this embodiment, an attribute layout plane that is subordinate is displayed in the list following (i.e., underneath) an attribute layout plane that is the main plane; and a prescribed blank area may be provided at the beginning of the name display of the attribute layout plane that is the subordinate. In FIG. 19, a front view and a partially enlarged view 1 are in a parental relationship, and so are a right-side view and sectional view A-A. Further, in a case where a plurality of subordinate attribute layout planes exist on a certain attribute layout plane, these are listed in accordance with a preset order in the manner described above.

In a case where an attribute layout plane is a sectional view in the setting of the parental relationship described above, the attribute layout plane that displays the cutting line indicating the cutting position of the cross section is the parent. Usually, with regard to the upper side in a case where an attribute layout plane corresponding to a sectional view is viewed as the drawing, the attribute layout plane that has been set parallel to the upper side and in the direction opposite to the sight line is set as the parent attribute layout plane. Further, in the case of a partially enlarged view, an attribute layout plane that displays an area to be enlarged is the parent in a two-dimensional drawing. Usually, an attribute layout plane that has been set in same plane as the parent attribute layout plane and in the same sight line direction is set as the parent attribute layout plane. The setting of parental relationship of the attribute layout plane is filed as setting information of the attribute layout plane in a manner similar to that of the attribute information.

(Generation of Auxiliary Drawing Information)

This embodiment is such that when attribute layout planes onto which a 3D model has been projected and the attribute information are output, auxiliary drawing information, which is for clarifying the set positions and set directions of the attribute layout planes, is output together with the information relating to the attribute layout planes based upon the state of the settings regarding the attribute layout planes set for the 3D model. The auxiliary drawing information will now be described.

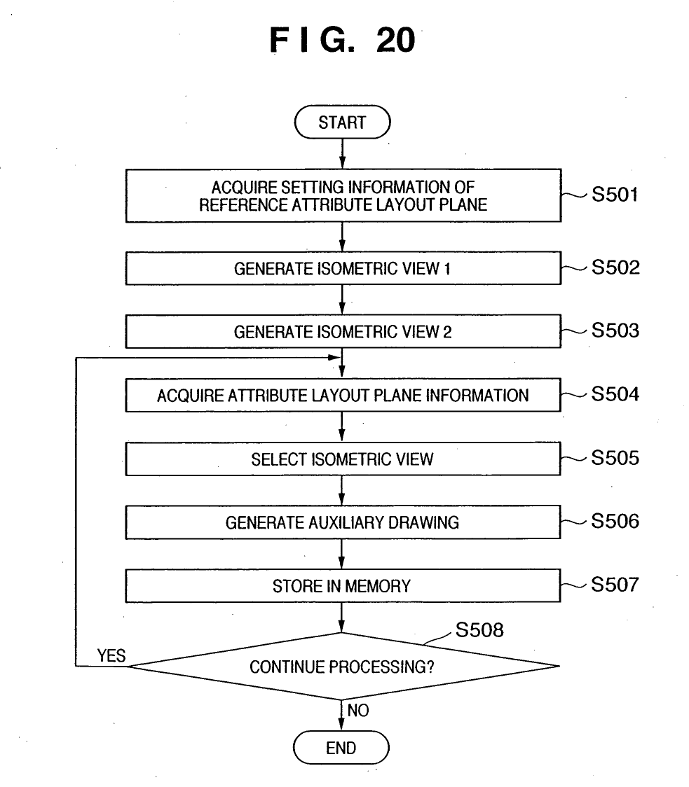

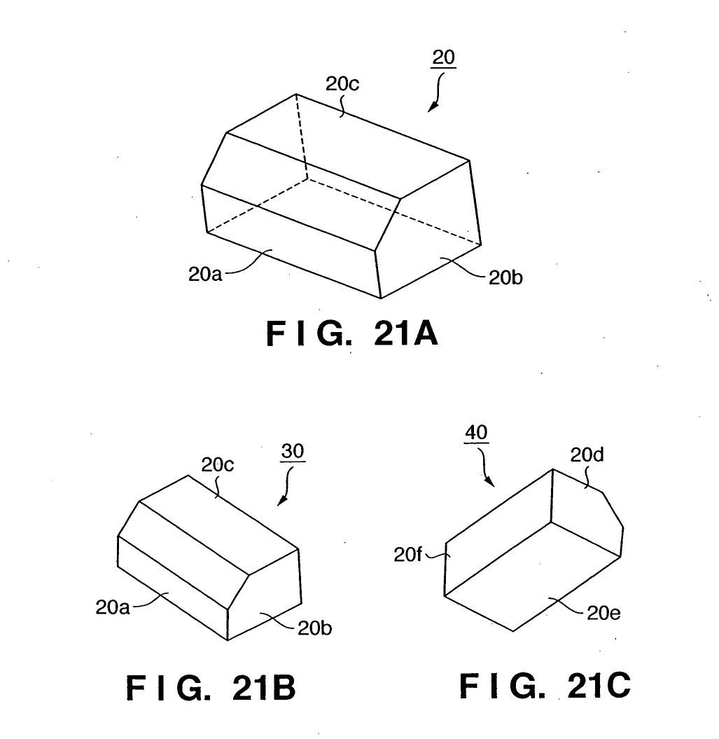

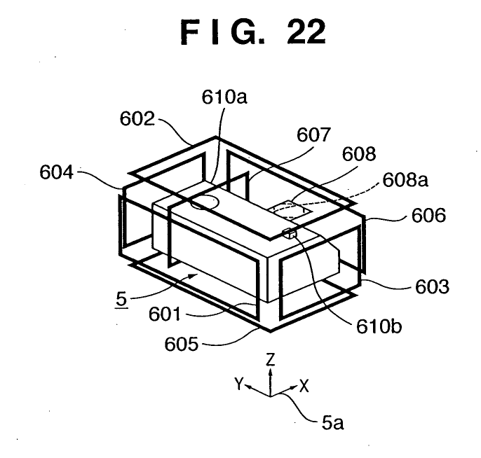

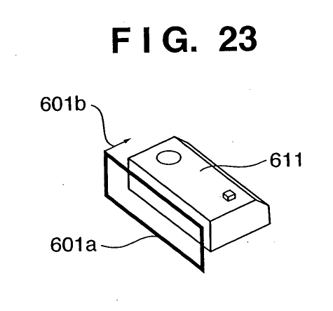

FIG. 20 is a flowchart illustrating a procedure for generating auxiliary drawing information by processing executed by the CPU 203, FIGS. 21A to 21C are diagrams for describing a method of generating auxiliary drawing information, FIG. 22 is a diagram illustrating a 3D model for which attribute information and attribute layout planes have been set, and FIGS. 23 to 27 are explanatory views illustrating examples of auxiliary drawing information.

The flow for generating the auxiliary drawing information will be described with reference to FIG. 20 and FIGS. 21A to 21C.

If the printing of an auxiliary drawing is selected in the above-described setting of print information, information relating to an attribute layout plane that has been set for a 3D model is acquired from information stored previously. More specifically, settings information of an attribute layout plane serving as a reference is acquired. That is, line-of-sight direction (a direction that enables verification of the 3D shape model and dimensions projected onto the attribute layout plane from a certain point of view, this direction being perpendicular to the attribute layout plane) and information relating to vertical orientation when the attribute layout plane is viewed as a drawing are acquired (step S501).

The attribute layout plane serving as the reference is set in advance. In this embodiment, the attribute layout plane of the front view is adopted as the attribute layout plane serving as the reference (referred to as the “reference attribute layout plane” below). In a case where an attribute layout plane of a front view has not been set for a 3D model, it will suffice to perform calculations by referring to the attribute layout plane of a plan view or of a side view, etc. Permutations of an attribute layout plane referred to and method of calculation corresponding to each attribute layout may be set in advance.

Next, two types of isometric views are generated at steps S502, S503. An isometric view is an equiangular projection view. This is a projection method in which a solid is projected with the X, Y, Z axes of three-dimensional space being viewed at respective ones of equal angles, namely at intervals of 120°. Accordingly, in order to display projection surfaces in six directions of a 3D model (front view, plan view, right-side view, left-side view, bottom view and back view), it is necessary to set isometric views viewed from at least two directions.

In this embodiment, the settings are such that isometric views in two directions illustrated in FIGS. 21B, 21C are generated for a 3D model 2 illustrated in FIG. 21A. In the isometric view of FIG. 21B, surfaces 20a, 20b and 20c of the 3D model 2 are displayed. In the isometric view of FIG. 21C, surfaces 20d, 20e and 20f of the 3D model 2 are displayed.

The display directions of isometric views are not limited to those of this embodiment. The method may be changed in accordance with the shape of the 3D model, the attribute information appended to the 3D model and the settings and structure of the attribute layout planes that correlate the attribute information. Further, the operator may make settings interactively from the input unit 207. Furthermore, it may be so arranged that isometric views of three of more directions (types) are set. The isometric views generated are stored temporarily in the internal storage device 209.

Next, at step S504, setting information of attribute layout planes for which the printout of auxiliary drawings has been specified in the above-mentioned attribute information settings is acquired from among the attribute layout planes that have been correlated with the 3D model. The setting information that is acquired is the name of the attribute layout plane set in advance, the set position, the line-of-sight direction (direction of the normal line) with respect to the 3D model and information relating to vertical orientation in a case where the attribute layout plane is viewed as a drawing.

Next, from among the plurality of isometric views generated at steps S502, S503 utilizing the settings information acquired at step S504, an isometric view suited to the set position and set position of the attribute layout plane to be printed out is selected in at step S505 in accordance with a command from the operator.

Next, at step S506, a pattern display indicating the set position and set direction of the attribute layout plane is generated and added to the isometric view selected at step S505.

In this embodiment, it is so arranged that the mode of clarifying the auxiliary drawing is changed based upon the setting of the attribute layout plane in order that the set position and set direction of the attribute layout plane will be transmitted reliably to the processes downstream. More specifically, the pattern display and mode of displaying the isometric views are changed for every type of attribute layout plane of a trigonometric projection, sectional view and partially enlarged view, etc.

The setting of mode of display will be described with reference to FIGS. 22 to 27.

As shown in FIG. 22, attribute layout planes 601, 602, 603, 604, 605, 606, 607, 608 are correlated with a 3D model 5.

The attribute layout planes 601 to 606 among these attribute layout planes are attribute layout planes that correspond to a trigonometric projection view. The attribute layout planes 601, 602, 603, 604, 605 and 606 are indicative of a front view, plan view, right-side view, left-side view, bottom view and back view, respectively.

The attribute layout plane 607 is one that corresponds to a sectional view, and the attribute layout plane 608 is one that corresponds to a partially enlarged view. The attribute layout plane 607 has a line-of-sight direction that is parallel to the Y axis of the coordinate system 5a of the 3D model, the up direction in a case where the plane is viewed as a drawing is set parallel to the Z axis, and the plane is placed on an axis that is at the center of a cylindrical hole 610a provided in the 3D model 5.

The attribute layout plane 608 has a line-of-sight direction that is a direction opposite the direction of the Z axis, and the up direction in a case where the plane is viewed as a drawing is set in a direction opposite the direction of the X axis. Furthermore, the attribute layout plane 608 is placed in a plane identical with the attribute layout plane 602 and is set such that a projection 610b provided on the 3D model 5 will be included in the display zone. An auxiliary FIG. 608a indicates the display zone. Furthermore, attribute information such as dimensions and remarks have been appended to figure elements such as the planes and ridge lines of the 3D model. It should be noted that attribute information has been deleted in FIG. 22.

Auxiliary drawing information shown in FIGS. 23 to 27 is generated based upon the above-described settings and procedure.

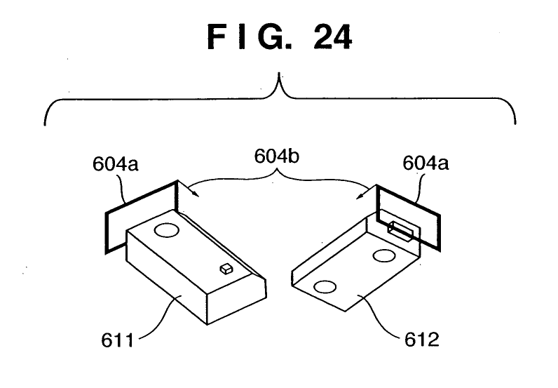

First, reference will be had to FIGS. 23 and 24 to describe an example of attribute layout planes that correspond to a trigonometric projection view. Here the attribute layout plane 601 corresponding to a front view and the attribute layout plane 604 corresponding to the left-side view among the six attribute layout planes 601 to 606 set for the 3D model 5 will be described.

FIG. 23 illustrates auxiliary drawing information that has been created based upon the setting of the attribute layout plane 601.

An isometric view 611 has been generated by the processing described above. A pattern display 601a is for clarifying the set position of the attribute layout plane 601. In FIG. 23, this display is expressed by a quadrangular frame in a manner similar to that of the attribute layout plane 601. A pattern display 601b is for clarifying the set direction of the attribute layout plane 601. This is expressed by an arrow in this example. The pattern display 601a is placed with respect to the isometric view 611 so as to have a positional relationship approximately the same as that of the attribute layout plane 601 that has been set for the 3D model 5. Further, the line-of-sight direction and the up direction (upper side) in a case where the attribute layout plane 601 is viewed as a drawing from the line-of-sight direction are expressed. The position of the pattern display 601b corresponds to the upper-left corner in a case where the attribute layout plane is viewed as a drawing. Accordingly, by observing the auxiliary drawing information, it is possible to reliably recognize the set position and set direction of the attribute layout plane.

Next, the attribute layout plane 604 corresponding to the left-side view will be described.

FIG. 24 illustrates auxiliary drawing information that has been created based upon the setting of the attribute layout plane 604.

Isometric views 611 and 612 have been generated by the processing described above. Pattern displays 604a and 604b are indicative of the line-of-sight direction and the up direction when the attribute layout plane is viewed as a drawing. The attribute layout plane 604 has its line-of-sight direction set in such a manner that the inward side of the display screen will be directed toward the front side when the 3D model 5 is displayed in the attitude of the drawing. In the example of FIG. 24, the settings are such that isometric views in two directions are displayed in order that the set position and direction of the attribute layout plane 604 will be easier to comprehend. Setting relating to the method of displaying the pattern displays 604a and 604b is similar to that in a case where auxiliary drawing information is created based upon the setting of the attribute layout plane 601.

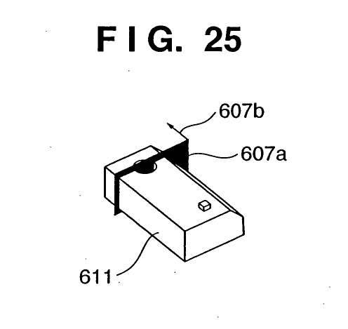

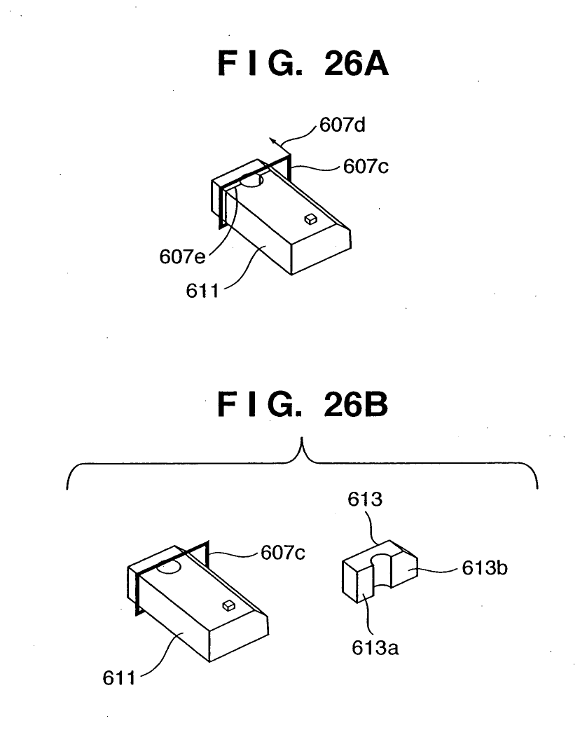

Reference will be had to FIG. 25 and FIGS. 26A, 26B to describe an example of an attribute layout plane that corresponds to a sectional view.

FIG. 25 illustrates auxiliary drawing information that has been created based upon the setting of the attribute layout plane 607. Pattern displays 607a, 607b have been placed at positions corresponding to the attribute layout plane 607 by a method similar to that described above. However, the display pattern 607a is expressed in a form in which the entirety of the quadrangular shape is filled in. Expressing the pattern in this manner makes it easier to ascertain the cutting position.

It should noted that the mode of displaying the auxiliary drawing information of the cross section is not limited to that of this embodiment. For example, the display may be presented as shown in FIGS. 26A, 26B.

In FIG. 26A, a cutting line 607e indicating the cutting position is placed at the isometric view 611. It should be noted that a pattern display 607c is expressed by a quadrangular double border. Further, a pattern display 607d is disposed by a method and expression similar to those described above.

FIG. 26B is obtained by displaying an isometric view 613 that is the result of cutting the 3D model 5 at the set position of the attribute layout plane 607. The isometric view 613 is displayed together with the isometric view 611. Furthermore, the recognizability of the cutting-position is enhanced by applying hatching or a shading pattern to the portions (613a and 613b) corresponding to the cutting plane of the 3D model 5 of isometric view 613.

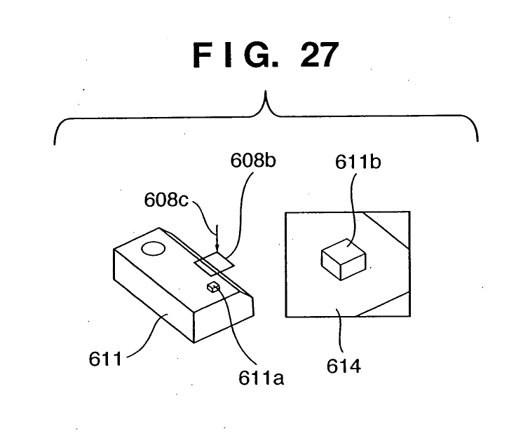

Next, reference will be had to FIG. 27 to describe an example of an attribute layout plane corresponding to a partially enlarged view.

FIG. 27 illustrates auxiliary drawing information that has been created based upon the setting of the attribute layout plane 608. Pattern displays 608b, 608c are disposed at a position corresponding to the attribute layout plane 608 by a method similar to that described above, and an enlarged view of a portion corresponding to an area in which the attribute layout plane 608 has been set is displayed.

The above description relates to an example of attribute layout planes set in line-of-sight directions, which are parallel to any of the X, Y, Z axes of the coordinate system 5a of 3D model 5, and in the up direction. However, the present invention is also applicable to attribute layout planes (which correspond to so-called two-dimensional auxiliary projection views) set in line-of-sight directions, which are not parallel to (i.e., which are oblique) to the X, Y, Z axes, and in the up direction when the attribute layout plane is seen as a drawing. In this case, it will suffice to adopt a setting such that isometric views will be displayed in two directions by processing similar to that in a case where auxiliary drawing information is created based upon the setting of the attribute layout plane 604 corresponding to the left-side view.

Further, isometric views different from those mentioned above may be generated based upon a relationship among the point of view and line-of-sight direction of an attribute layout plane, the up direction when the attribute layout plane is viewed as a drawing and the coordinate system of the 3D model.

The auxiliary drawing data that has been generated by the above processing is stored in the internal storage device 209 temporarily to complete the generation of auxiliary drawing data for a certain attribute layout plane.

Next, whether an attribute layout plane for which auxiliary drawing data has not been generated exists is determined (step S508). If such an attribute layout plane exists, the processing of steps S504 to S507 is repeated, auxiliary drawing data of all attribute layout planes for which printout of auxiliary drawings has been specified is generated and processing is completed.

As mentioned above, the generated auxiliary drawing data is generated as output data for output to an output unit such as a display unit or printer together with other print information. Depending upon a judgement made by the operator, a preview image displayed on the display unit 205 is checked as necessary, after which the image is printed out by executing prescribed processing. As shown in FIG. 16, the preview image is displayed in a window 702 of a display screen 204a of the display unit 205 together with the auxiliary drawing information to be printed out. The operator selects and checks the desired auxiliary drawing information from a pull-down menu 703.

(Output of Print Data)

An example of result of printing that has been output by the above processing will be described.

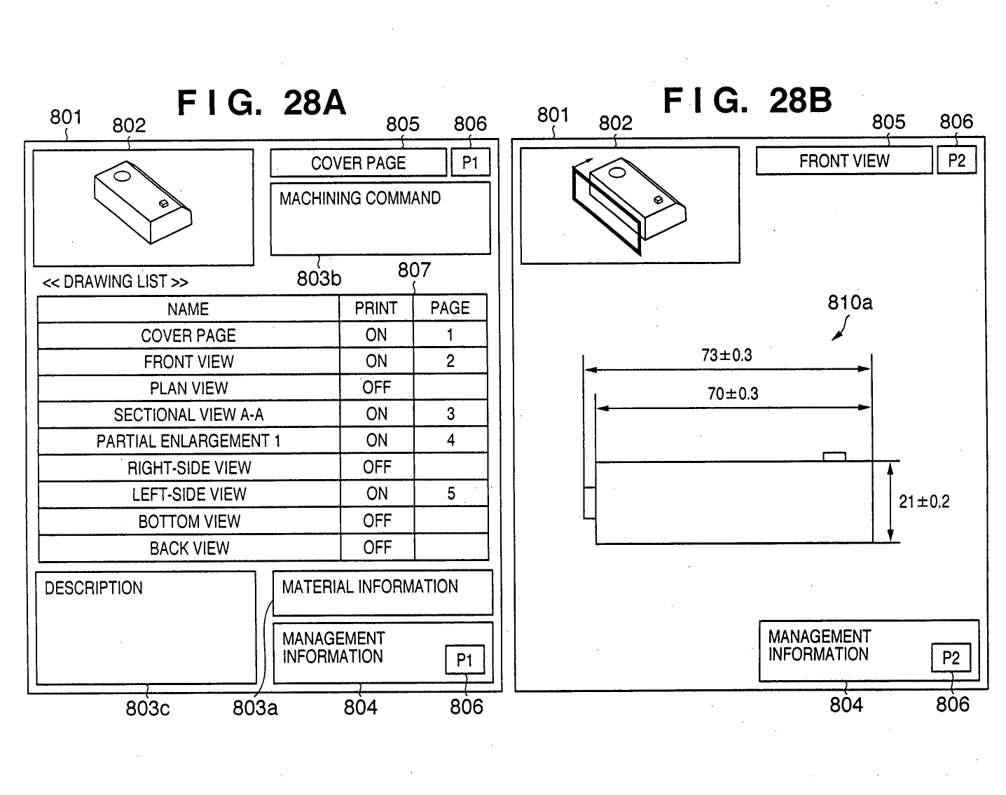

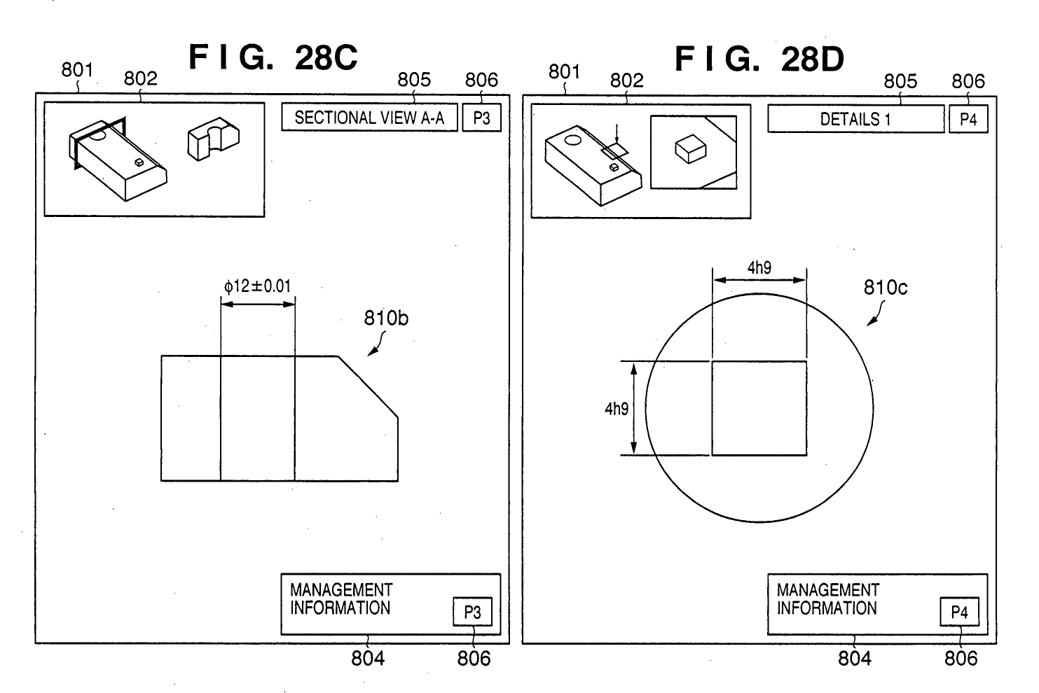

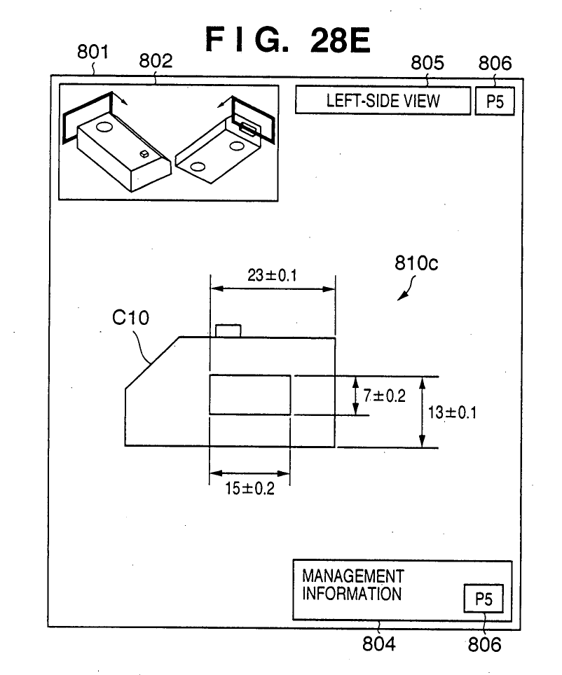

FIGS. 28A to 28E are diagrams illustrating examples in which the 3D model 5 shown in FIG. 22 and attribute information appended to the 3D model 5 have been printed out by the above-described processing.

FIG. 28A, which corresponds to a cover page, has an output area 801 in which are disposed an auxiliary drawing information area 802, a material information area 803a, machining designation area 803b and description area 803c, which constitute design information, a management information area 804, a name display area 805, a page area 806 and a drawing list 807. Information is filled in these areas and output by the above-described processing together with the attribute information that has been appended to the 3D model.

FIGS. 28B to 28E correspond to desired two-dimensional drawings and illustrate image information 810a corresponding to a front view, image information 810b corresponding to a sectional view, image information 810c corresponding to a partially enlarged view, and image information 810d corresponding to a left-side view.

In a case where a number of attribute layout planes have been set for a 3D model, it will suffice to output them on a page separate from the cover page.

Further, printout data generated by the above-described process may be stored as a file together with the 3D model or it may be so arranged that only the output data is filed.

Further, since the printout data is in a data format that can be handled by an ordinary personal computer, it is possible to perform the printout in an environment that is devoid of a CAD apparatus.

### C. Third Embodiment

A third embodiment of the present invention will now be described in detail with reference to the drawings.

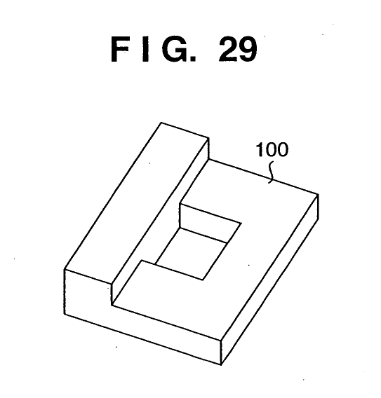

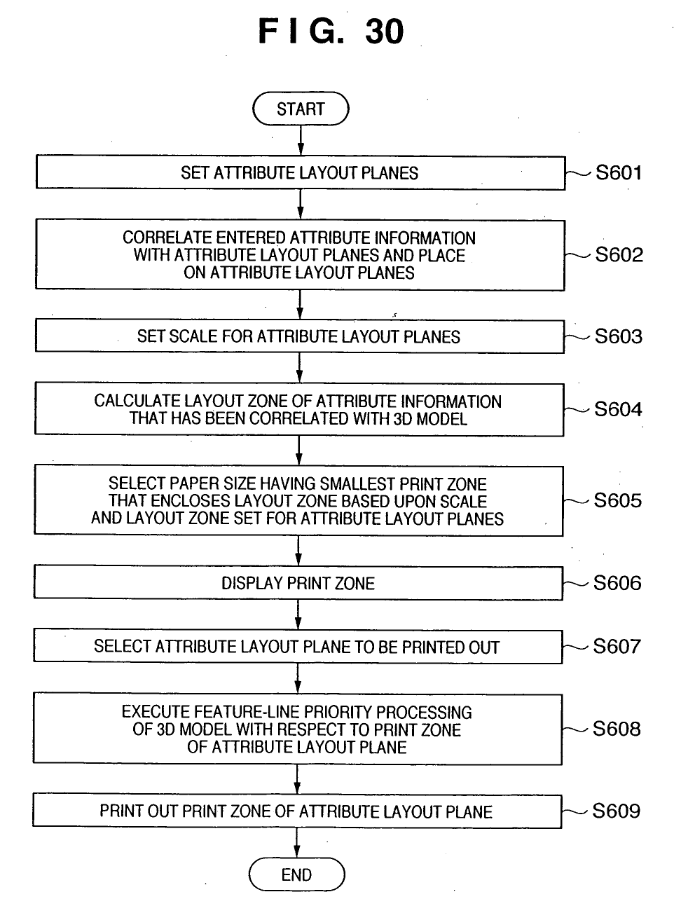

FIG. 29 illustrates an example of a 3D model 100 useful in describing this embodiment of the present invention. Reference will be had to the 3D model 100 in FIG. 29 to describe processing for printing out a drawing in this embodiment from settings of attribute information in line with a flowchart illustrated in FIG. 30.

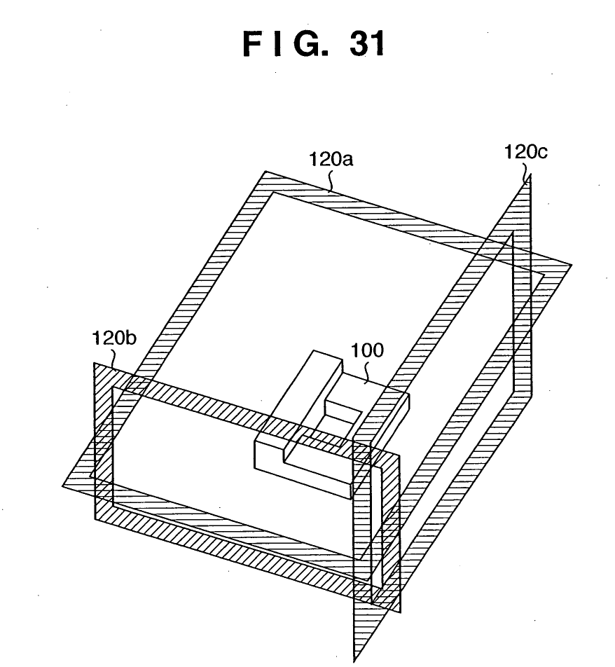

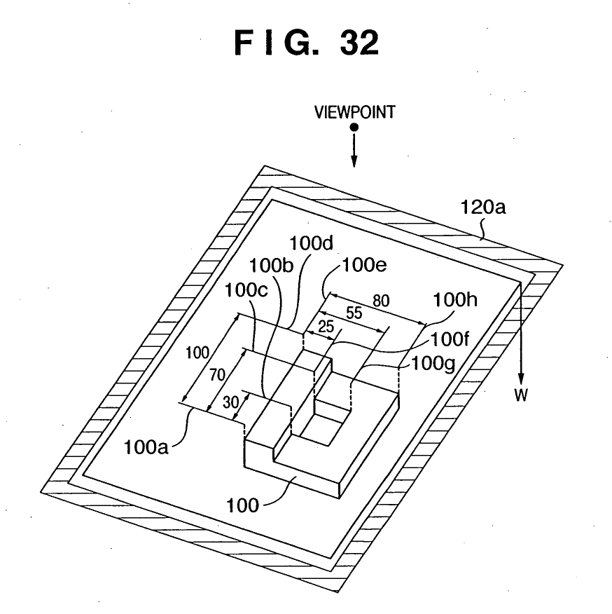

First, at step S601, attribute layout planes 120a, 120b, 120c (FIG. 31) for expressing attribute information such as the dimensions and tolerance of the 3D model 100 are set for the 3D model 100. FIG. 32 illustrates, in three dimensions, the manner in which the attribute information has been correlated with the attribute layout plane 120a. This will be described taking the attribute layout plane 120a as an example.

Next, at step S602, the necessary attribute information such as dimensions is input, each item of attribute information is correlated with any of the attribute layout planes 120a to 120c and the attribute information is placed at desired positions on the attribute layout planes 120a to 120c (see FIG. 32).

Next, at step S603, a scale that allows the shape of the 3D model 100 and attribute information to be seen clearly without being misunderstood is set for the attribute layout planes 120a to 120c. In this embodiment, a scale of 1:1 is set with regard to the attribute layout planes 120a, 120b, 120c. The display and printout of the 3D model 100 and attribute information are executed based upon the scale set.

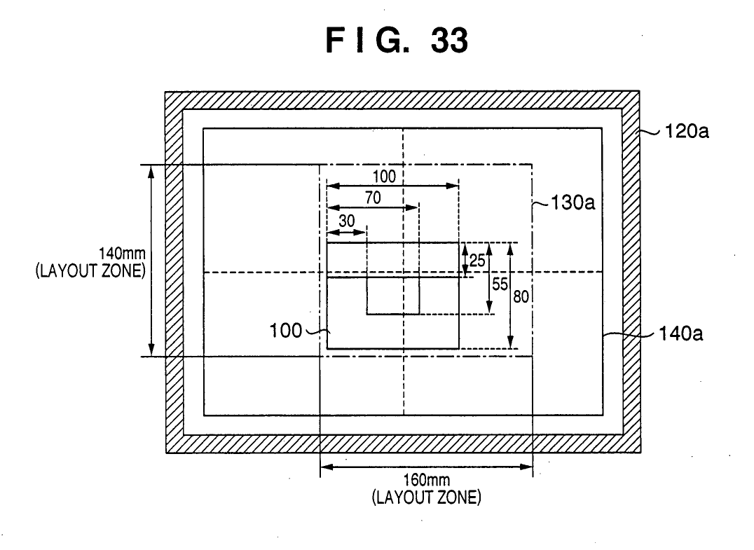

Next, at step S604, the layout zone within the 3D space of the attribute information that has been correlated with the 3D model 100 is calculated for each of the attribute layout planes 120a to 120c. The layout zone is calculated as a rectangular shape that encompasses the entirety of the 3D model 100 and correlated attribute information in a display state in which the attribute layout planes 120a to 120c are displayed face-up. For example, the area enclosed by the line in FIG. 33 is a layout zone 130a.

This is followed by step S605, at which the apparatus selects, from the set scale and layout zone 130a, a recording medium such as paper having a print zone 140a (the solid line) of the smallest size that encloses the planar model indicated by the dotted line and the layout zone 130a of the attribute information.

The set-up is such that the center of the layout zone 130a will coincide with the center of the print zone 140a of the selected recording medium (FIG. 33). Of course, the layout zone 130a may be revised by shifting it relative to the print zone 140a as necessary (FIG. 33).

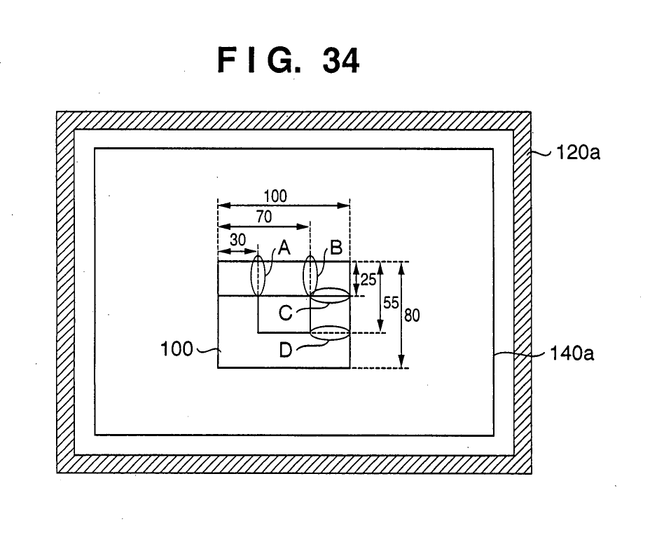

Next, at step S606, the print zone 140a is displayed on the attribute layout plane 120a as the line of a rectangle indicative of the print zone (FIGS. 33, 34). If the display screen is made a display zone conforming to the scale at this time, the size of the print zone 140a displayed will be the same as the size of the actual print zone. That is, if a printing medium of size A3 is laid on the display screen of print zone 140a of size A3, for example, then both print zones will coincide. By displaying the print zone 140a, the operator can clearly ascertain the range over which printing can be performed.

Next, any of the attribute layout planes 120a to 120c to be printed out is selected and specified at step S607. Here the plane 120a is selected as the selection candidate.

Next, at step S608 in response to a print command from the operator, the 3D model 100 as seen from the direction of the normal to the designated attribute layout plane and the attribute information that has been correlated with the attribute layout plane are printed out based upon the print zone and stipulated paper size set at step S605. More specifically, image information within the print zone set on the attribute layout plane to be output is converted to a prescribed format in the image processing unit 204, after which the information is stored temporarily in RAM 201 and sent to the output unit 206, whereby the information is printed out using the set size of the recording medium. The image information of the 3D model 100 at this time is printed on a recording medium of size A4 corresponding to the print zone 140a set based upon the scale. That is, the result of printout reflects the scale of the 3D model.

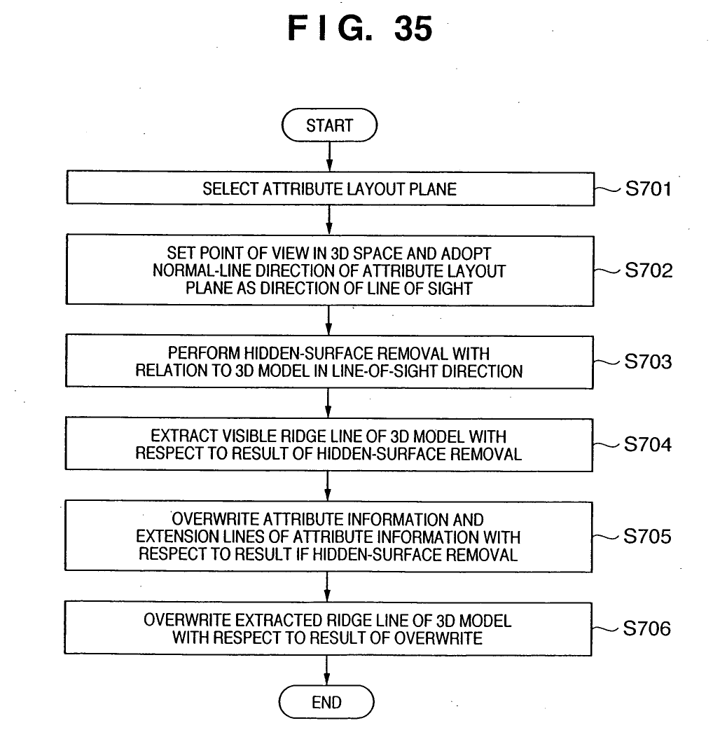

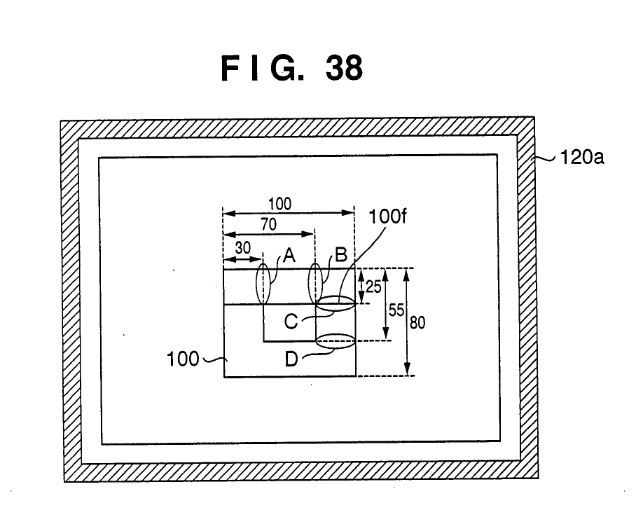

In this print processing, feature-line priority processing is executed. This is processing for placing a ridge line, which is a feature line of the 3D model, in front of the leader line of the attribute information. For example, in FIG. 32, drawing lines 100a to 100f of attribute information placed in correlation with the attribute layout plane 120a are disposed before the 3D model 100 as seen from a normal-line direction W of the attribute layout plane 120a. Under these conditions, the leader lines will unfortunately be printed out preferentially. In order to avoid this situation, preference is given to processing for printing the ridge lines of the 3D model 100 at portions A to D in FIG. 38 rather than the leader lines 100b, 100c, 100f, 100g of the attribute information, thereby clarifying whether or not these ridge lines exist. The above-described feature-line priority processing is executed. An example of the flow of this feature-line priority processing is illustrated in FIG. 35.

In FIG. 35, a step S701 the processing of which is the same as that of step S607 in FIG. 30 is illustrated for the sake of explanation. First, the attribute layout plane 120a is selected at step S701. Then, at step S702, a point of view is set with respect to the attribute layout plane 120a in the three-dimensional space in which the 3D model 100 has been set, and the normal-line direction W of the attribute layout plane 120a is adopted as the direction of line of sight.

Next, at step S703, in relation solely to the 3D model 100, hidden-surface removal processing is executed by a well-known technique referred to as the so-called Z buffer method (Z buffering) in the image processing unit 204 with respect to the line-of-sight direction.

Next, at step S704, portions that can be checked among the ridge lines of the 3D model 100 from the line-of-sight direction are extracted by processing in the CPU 203 with respect to the result of hidden-surface removal. The result of extraction is stored temporarily in a RAM 201, etc.

This is followed by step S705, at which the attribute information and the leader lines of the attribute information are written over the result of hidden-surface removal by processing in the image processing unit 204 through a method similar to that of the Z buffer method. In the state that prevails after overwrite, the attribute information and the leader lines 10a to 10h of the attribute information, inclusive of attribute information extension line 100f overlapping the ridge line of the 3D model 100, are capable of checked at a priority higher than that of the 3D model 100.

Next, at step S706, the visible ridge lines of the 3D model 100 stored temporarily at step S704 are written over the result of overwrite of attribute information (extension lines). Owing to the overwrite processing, all of the visible ridge lines of the 3D model 100 are in a state in which they are printed at a priority higher than that of the leader lines 100a to 100h of the attribute information. The image information in this state, namely the image as seen from the normal-line direction of the attribute layout plane 120a, is FIG. 34. It can readily be understood in FIG. 34 that a ridge line of the 3D model 100 is present at portion C and that no ridge lines of the 3D model 100 are present at portions A, B and D.

Next, at step S609, the image information that has undergone feature-line priority processing is transferred to the output unit 206. The latter prints out the image information transferred in the size of the recording medium selected in advance.

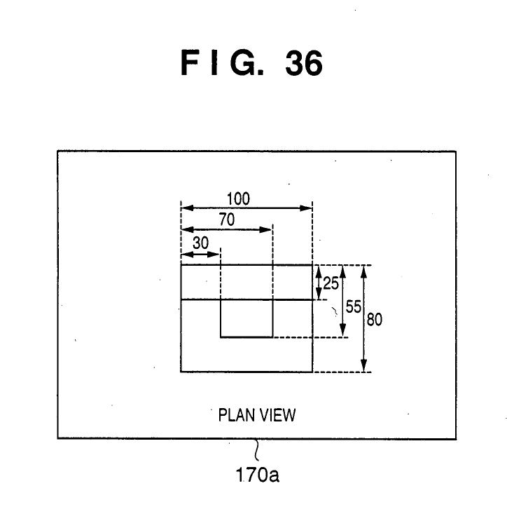

The result obtained by printing out the attribute layout plane 120a is illustrated in FIG. 36. In FIG. 36, the ridge lines of the 3D model 100 are printed out in the color black and the attribute information is printed out in the color gray. In the result of printout, shading processing may be applied to the 3D model 100 as necessary. Further, in order to clarify the distinction between the 3D model 100 and the attribute information or extension lines of the attribute information, these may be printed in colors that differ from each other.

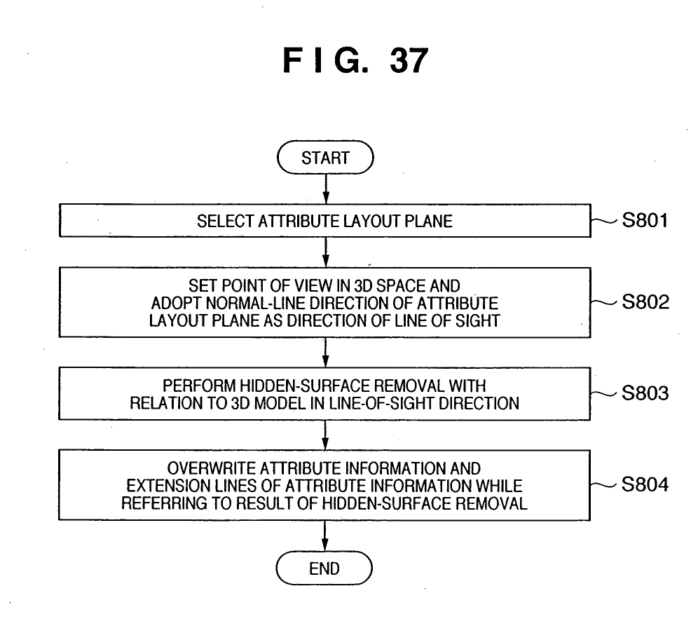

In the above-described embodiment, feature-line priority processing is executed according to the flowchart of FIG. 35. However, this processing can also be executed according to a flowchart shown in FIG. 37, by way of example. Steps S801 to S803 in FIG. 37 are similar to steps S601 to S603 in FIG. 35 and need not be described.

The result of hidden-surface removal processing relating to the 3D model at step S803 is stored in RAM 201 at step S804. The attribute information and the leader lines of the attribute information are overwritten while reference is had to color information of each item of pixel data that is the result of hidden-surface removal processing. That is, if the color information of the pixel data has the color of ridge lines of the 3D model, overwrite is inhibited; if it has a color other than this, overwrite is carried out. The visible ridge lines of the 3D model can be maintained as image information by executing such processing for all pixels. Thus, the present invention is not limited to the method of feature-line priority processing and is applicable to any method.

In accordance with this embodiment as described above, the ridge lines of a 3D model are printed at a higher priority than that of the leader lines of the dimensions. As a result, the shape of the model can be readily ascertained from the drawing.

For example, with regard to the 3D model 100 of FIG. 29, dimensions constituting the attribute information are correlated with the attribute layout plane 120a of the kind shown in FIG. 32, and the dimensions are placed on the attribute layout plane 120a. In this case, the dimensions are drawn out from the 3D model 100 to a desired location on the attribute layout plane 120a by the leader lines 100a to 100h.

With the structure of the conventional information processing apparatus described above, a case where an attribute layout plane is observed from the direction of a certain point of view and a case where the leader lines of attribute information are situated in front of the 3D model are conceivable.

For example, in FIG. 32, the leader lines 100a to 100h are placed on the attribute layout plane 120a. At this time, however, the leader lines are placed in front of the 3D model 100. FIG. 38 illustrates the attribute layout plane 120a in a state in which the 3D model 100 of FIG. 32 and the attribute information are observed from the normal-line direction of the plane. The portion C where a ridge line of the 3D model 100 and the leader line 100f overlap is such that the leader line 100f situated in front is displayed.

The reason for this is as follows: In order to express a detailed shape or the like in the pixel data that is output from an information processing apparatus to a display unit, the line thickness of both the ridge lines of the 3D model and the leader lines of the attribute information is one pixel. This means that the ridge lines of the 3D model situated in back are not displayed.

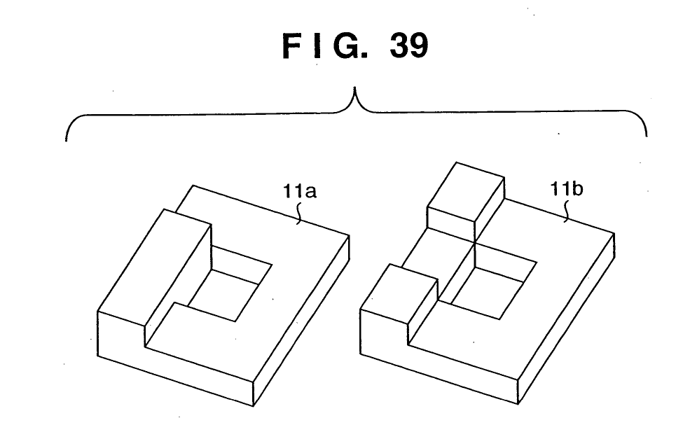

As a result, there is the danger that the operator may misinterpret the shape of the 3D model. For example, in the display or printout of FIG. 38, it is not clear whether ridge lines of the 3D model 100 are in back of portions A to D where the leader lines overlap the 3D model. Consequently, various shapes 11a and 11b of the kind shown in FIG. 39 are conceivable and it can be assumed that the operator will not be able to specify the shape or to ascertain the shape intuitively. In order to specify the shape, it will be necessary for the operator to perform a troublesome task that includes making a careful examination taking into consideration the results of other processing and then analyzing the shape to comprehend it.

If the third embodiment is applied, however, such a detrimental effect can be eliminated.

As many apparently widely different embodiments of the present invention can be made without departing from the spirit and scope thereof, it is to be understood that the invention is not limited to the specific embodiments thereof except as defined in the appended claims,

### CLAIM OF PRIORITY

This application claims priorities from Japanese Patent Application No. 2003-372457 filed on Oct. 31, 2003, Japanese Patent Application No. 2003-380078 filed on Nov. 10, 2003 and Japanese Patent Application No. 2003-382684 field on Nov. 12, 2003, the entire contents of which are hereby incorporated by reference herein.

1. An information processing apparatus comprising:
a display control device adapted to display a plane, in which attribute information concerning a three-dimensional model is laid out, in three-dimensional space identical with that of the three-dimensional model; and
an output device, which is responsive to designation by a designating device of the plane displayed by said display control device in the same three-dimensional space as that of the three-dimensional model, adapted to output print data of the three-dimensional model and of the attribute information as viewed from a normal-line direction of the virtual plane designated.

2. The apparatus according to claim 1, wherein the normal-line direction of the plane differs from a line-of-sight direction of the three-dimensional model on said display means.

3. The apparatus according to claim 1, further comprising a setting device adapted to set a zone of the print data with respect to the virtual plane.

4. The apparatus according to claim 3, wherein said setting device sets the zone of print data in stages.

5. The apparatus according to claim 1, wherein said setting device sets a scale for displaying the three-dimensional model and attribute information as viewed from the normal-line direction of the virtual plane.

6. The apparatus according to claim 5, wherein said setting device sets the zone of print data based upon the scale.

7. The apparatus according to claim 1, wherein said output device outputs print data plane by plane.

8. An information processing method comprising:
a display step of virtually displaying planes, in which attribute information concerning a three-dimensional model is laid out, in three-dimensional space identical with that of the three-dimensional model; and
an output step, which is responsive to designation for printing of a plane displayed at said display step, of outputting print data of the three-dimensional model and of the attribute information as viewed from a normal-line direction of the virtual plane designated.

9. The method according to claim 8, wherein the normal-line direction of the plane differs from a line-of-sight direction of the three-dimensional model on said display means.

10. The method according to claim 8, further comprising a print-zone setting step of setting a zone of the print data with respect to the virtual plane.

11. The method according to claim 10, wherein said print-zone setting step sets the zone of print data in stages.

12. The method according to claim 1, further comprising a scale setting step of setting a scale for displaying the three-dimensional model and attribute information as viewed from the normal-line direction of the virtual plane.

13. The method according to claim 12, wherein said print-zone setting step sets the zone of print data based upon the scale.

14. The method according to claim 8, wherein said output step outputs print data plane by plane.

15. An information processing execution program comprising:
program code for executing a display step of virtually displaying planes, in which attribute information concerning a three-dimensional model is laid out, in three-dimensional space identical with that of the three-dimensional model; and
program code for executing an output step, which is responsive to designation for printing of a plane displayed at said display step in the same three-dimensional space as that of the three-dimensional model, of outputting print data of the three-dimensional model and of the attribute information as viewed from a normal-line direction of the virtual plane designated.

16. A storage medium storing the information processing execution program set forth in claim 15.

17. An information processing apparatus comprising:
acquisition means for acquiring information relating to set state of an attribute layout plane in which attribute information concerning a three-dimensional model is laid out; and
generating means for generating auxiliary drawing information, which is for clarifying set position and set direction of the attribute layout plane that is output together with information relating to the attribute layout plane, based upon information relating to the setting information.

18. The apparatus according to claim 17, wherein the attribute layout plane is laid out virtually in three-dimensional space identical with that of the three-dimensional model.

19. The apparatus according to claim 17, wherein the auxiliary drawing information is printed out together with the information relating to the attribute layout plane.

20. The apparatus according to claim 19, wherein in a case where a plurality of attribute layout planes exist for the three-dimensional model, the attribute layout planes are printed out in an order that has been set in advance.

21. The apparatus according to claim 17, wherein the auxiliary drawing information clarifies the set position and set direction of the attribute layout plane in a solid perspective view of the three-dimensional model.

22. The apparatus according to claim 21, wherein the auxiliary drawing information clarifies the set position and set direction of the attribute layout plane in an isometric view of the three-dimensional model.

23. The apparatus according to claim 22, wherein said generating means generates isometric views in at least two directions of the three-dimensional model before the auxiliary drawing information is output, and selects and outputs, as the auxiliary drawing information, an isometric view, which corresponds to the set state of the plane in which the attribute information has been laid out, from the isometric views of the at least two directions.

24. The apparatus according to claim 22, wherein said generating means changes mode of clarification of at least one of the set position and set direction of the plane based upon the set state of the plane in which the attribute information has been laid out.

25. An information processing method comprising generating auxiliary drawing information, which is for clarifying set position and set direction of an attribute layout plane that is output together with information relating to the attribute layout plane, based upon a set state of the attribute layout plane in which attribute information concerning a three-dimensional model is laid out.

26. A program for executing the information processing method set forth in claim 25.

27. A storage medium storing the information processing program set forth in claim 26.

28. An information processing apparatus comprising:
display means for virtually displaying planes, in which attribute information concerning a three-dimensional model is laid out, in three-dimensional space identical with that of the three-dimensional model; and
image control means for giving a higher priority to a feature line of the three-dimensional model than to a leader line of the attribute information if the feature line and the leader line overlap.

29. The apparatus according to claim 28, wherein said image control means executes image control for giving a higher priority to a feature line of the three-dimensional model than to a leader line of the attribute information if a normal-line direction of the plane coincides with a line-of-sight direction of the three-dimensional model displayed by said display means.

30. The apparatus according to claim 28, further comprising output means for outputting image information, which has been controlled by said image control means, as print data.

31. The apparatus according to claim 30, wherein said image control means gives a higher priority to a feature line of the three-dimensional model than to a leader line of the attribute information if the feature line of the three-dimensional model and the leader line of the attribute information overlap as viewed from a normal-line direction of the plane irrespective of a line-of-sight direction of the three-dimensional model displayed by said display means.

32. An information processing method comprising:
a display step of virtually displaying planes, in which attribute information concerning a three-dimensional model is laid out, in three-dimensional space identical with that of the three-dimensional model; and
an image control step of giving a higher priority to a feature line of the three-dimensional model than to a leader line of the attribute information if the feature line of the three-dimensional model and the leader line of the attribute information overlap.

33. The method according to claim 32, wherein said image control step executes image control for giving a higher priority to a feature line of the three-dimensional model than to a leader line of the attribute information if a normal-line direction of the plane coincides with a line-of-sight direction of the three-dimensional model displayed at said display step.

34. The method according to claim 32, further comprising an output step of outputting image information, which has been controlled at said image control step, as print data.

35. The method according to claim 34, wherein said image control step gives a higher priority to a feature line of the three-dimensional model than to a leader line of the attribute information if the feature line of the three-dimensional model and the leader line of the attribute information overlap as viewed from a normal-line direction of the plane irrespective of a line-of-sight direction of the three-dimensional model displayed at said display step.

36. An information processing execution program comprising:
program code for executing a display step of virtually displaying planes, in which attribute information concerning a three-dimensional model is laid out, in three-dimensional space identical with that of the three-dimensional model; and
program code for executing an image control step of giving a higher priority to a feature line of the three-dimensional model than to a leader line of the attribute information if the feature line of the three-dimensional model and the leader line of the attribute information overlap.

37. A storage medium storing the program set forth in claim 36.
